(19) United States
(12) Patent Application Publication
(10) Pub. No.: US 2012/0234265 A1
(43) Pub. Date: Sep. 20, 2012

(54) Hydrogen Fuel Systems

(76) Inventor: Duanne Y. Ball, Surprise, AZ (US)

(21) Appl. No.: 13/419,357

(22) Filed: Mar. 13, 2012

Related U.S. Application Data
(60) Provisional application No. 61/452,571, filed on Mar. 14, 2011.
(60) Provisional application No. 61/484,574, filed on May 10, 2011.

(51) Int. Cl. F02B 43/10; C25B 1/06; C25B 9/18; C25B 9/00; C25B 9/08

(52) U.S. Cl. 123/3; 204/278; 204/266; 204/258; 204/270

(57) ABSTRACT

Improved electrolysis systems for production of Brown's gas. The produced Brown's gas is made available for co-combustion with hydrocarbon fuel in an internal combustion engine to improve the fuel efficiency of the internal combustion engine.

### CROSS-REFERENCE TO RELATED APPLICATION

The present application is related to and claims priority from prior provisional application Ser. No. 61/452,571, filed Mar. 14, 2011, entitled “HYDROGEN FUEL SYSTEMS”; and, this application is related to and claims priority from prior provisional application Ser. No. 61/484,574, filed May 10, 2011, entitled “HYDROGEN FUEL SYSTEMS”, the contents of both of which are incorporated herein by this reference and are not admitted to be prior art with respect to the present invention by the mention in this cross-reference section.

### BACKGROUND

This invention relates to providing a system for improved production of Brown's gas by electrolysis. More particularly, this invention relates to providing a system for improved production of Brown's gas to be made available to at least assist fueling an internal combustion engine. More particularly, this invention relates to providing a system for improved production of Brown's gas for delivery to an internal combustion engine to at least improve the hydrocarbon-burning fuel efficiency of the internal combustion engine.

### OBJECTS AND FEATURES OF THE INVENTION

A primary object and feature of the present invention is to provide a system to electrolyze water to produce Brown's gas. Another object and feature of the present invention is to provide such a system comprising a plurality of electrolysis reactors for electrolyzing water to produce Brown's gas. Yet another object and feature of the present invention is to provide a system to electrolyze water comprising a plurality of cathode plates and a plurality of anode plates arranged in alternating ordered arrangement. It is a further object and feature of the present invention to provide a system to electrolyze water comprising a plurality of directionally-alternating electric fields.

Yet another object and feature of the present invention is to provide a system to electrolyze water which continuously circulates water through a plurality of electrolysis reactors. Another object and feature of the present invention is to provide a system which sweeps Brown's gas products through a plurality of electrolysis reactors to at least one product collector.

Yet another object and feature of the present invention is to provide a system to electrolyze water to produce Brown's gas, in which the produced Brown's gas is made available to assist fueling an internal combustion engine. Another object and feature of the present invention is provide a system to electrolyze water to produce Brown's gas, in which the produced Brown's gas is made available to be co-combusted with a hydrocarbon fuel in an internal combustion engine to improve the fuel efficiency of the internal combustion engine. An additional object and feature of the present invention is to provide a system which varies production of Brown's gas with variation in engine speed.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a system, relating to electrolyzing water, when electrically coupled to at least one electrical source, to provide at least one combustible hydrogen fuel to at least assist fueling at least one internal combustion engine, comprising: at least one electrolyzer structured and arranged to electrolyze the water to produce hydrogen and oxygen; wherein such at least one electrolyzer comprises at least one electrolysis reactor structured and arranged to perform electrolysis reaction with the water; at least one continuous-flow circulator structured and arranged to circulate continuous flow of the water through such at least one electrolyzer; wherein such at least one continuous-flow circulator comprises at least one product sweeper structured and arranged to sweep such hydrogen and such oxygen through such at least one electrolysis reactor; and wherein such hydrogen and such oxygen are available to inject in the at least one internal combustion engine to assist fueling the at least one internal combustion engine.

Moreover, it provides such a system wherein such at least one electrolyzer further comprises at least one reactor-container structured and arranged to contain such at least one electrolysis reactor. Additionally, it provides such a system wherein such at least one electrolyzer further comprises at least one directionally-alternating electric field generator structured and arranged to generate at least one directionally-alternating series of electric fields. Also, it provides such a system wherein such at least one electrolysis reactor comprises: at least one cathode plate structured and arranged to provide at least two surfaces of negative electrical charge; and at least one anode plate structured and arranged to provide at least two surfaces of positive electrical charge; wherein such hydrogen is produced on at least one of such at least two surfaces of negative electrical charge; and wherein such oxygen is produced on at least one of such at least two surfaces of positive electrical charge.

In addition, it provides such a system wherein such at least one electrolysis reactor further comprises: at least one parallel-alignment geometry structured and arranged to geometrically-align such at least one cathode plate and such at least one anode plate in at least one parallel arrangement; at least one edge-alignment geometry structured and arranged to geometrically-align at least one bottom edge of such at least one cathode plate with at least one bottom edge of such at least one anode plate in at least one common plane; and at least one surface-separator structured and arranged to separate such at least one of such at least two surfaces of negative electrical charge from such at least one of such at least two surfaces of positive electrical charge by at least one fixed separation.

And, it provides such a system wherein such at least one electrolyzer further comprises: at least one number (n) of such at least one anode plates; and at least one plurality (n+1) of such at least one cathode plates. Further, it provides such a system wherein such at least one electrolyzer is further structured and arranged to comprise: in at least one alternating arrangement, such at least one number (n) of such at least one anode plates and such at least one plurality (n+1) of such at least one cathode plates in at least one alternating ordered sequence; wherein such at least one alternating arrangement generates at least one plurality (2n) of such at least one electrolysis reactors.

Even further, it provides such a system wherein: such at least one cathode plate comprises at least one titanium plate with a width of about five inches and a height of about seven inches; and such at least one anode plate comprises at least one titanium plate with width of about five inches and a height of about seven inches. Moreover, it provides such a system wherein such at least one titanium plate comprises at least one mixed metal oxide coating. Additionally, it provides such a system wherein such at least one mixed metal oxide coating comprises at least one iridium-titanium oxide coating with a thickness of about eight to about twelve microns. Also, it provides such a system wherein such at least one surface-separator separates such at least one of such at least two surfaces of negative electrical charge and such at least one of such at least two surfaces of positive electrical charge by at least about one-seventh of an inch.

In addition, it provides such a system further comprising: at least one cathode current-transmitter-assistor structured and arranged to assist transmission of current between such at least one plurality (n+1) of such at least one cathode plates; and at least one anode current-transmitter-assistor structured and arranged to assist transmission of current between such at least one number (n) of such at least one anode plates. And, it provides such a system wherein: such at least one cathode current-transmitter-assistor comprises at least one titanium pole with a diameter of about one-quarter of an inch; and such at least one anode current-transmitter-assistor comprises at least one titanium pole with a diameter of about one-quarter of an inch.

Further, it provides such a system further comprising at least one water-flow distributor structured and arranged to distribute water flow evenly to each of such at least one plurality of such at least one electrolysis reactors. Even further, it provides such a system wherein such at least one water-flow distributor comprises at least one baffle distributor. Moreover, it provides such a system further comprising at least one water storer structured and arranged to store the water for electrolysis by such at least one electrolyzer. Additionally, it provides such a system wherein such at least one continuous-flow circulator comprises at least one pump structured and arranged to pump the water between such at least one water storer and such at least one electrolyzer.

Also, it provides such a system wherein such at least one water storer comprises at least one water-deliverer structured and arranged to deliver the water to such at least one electrolyzer. In addition, it provides such a system wherein such at least one water storer comprises at least one water-receiver structured and arranged to receive both un-reacted water and such hydrogen and such oxygen, from such at least one electrolyzer. And, it provides such a system wherein such at least one water storer comprises at least one product separator structured and arranged to separate such hydrogen and such oxygen from such un-reacted water. Further, it provides such a system wherein such at least one water storer comprises at least one product-deliverer structured and arranged to deliver such hydrogen and such oxygen, separated by such at least one product separator, to the at least one internal combustion engine.

In accordance with another preferred embodiment hereof, this invention provides a system, relating to electrolyzing water, when electrically coupled to at least one electrical source, to provide at least one combustible hydrogen fuel to at least assist fueling at least one internal combustion engine, comprising: at least one electrolyzer structured and arranged to electrolyze water to produce hydrogen and oxygen; wherein such at least one electrolyzer comprises at least one electrolysis reactor structured and arranged to perform electrolysis reaction with the water; and at least one continuous-flow circulator structured and arranged to circulate continuous flow of the water through such at least one electrolyzer; wherein such at least one continuous-flow circulator comprises at least one product sweeper structured and arranged to sweep such hydrogen and such oxygen through such at least one electrolysis reactor; wherein such at least one electrolyzer further comprises at least one reactor-container structured and arranged to contain such at least one electrolysis reactor; wherein such at least one electrolyzer further comprises at least one directionally-alternating electric field generator structured and arranged to generate at least one directionally-alternating series of electric fields; wherein such at least one electrolysis reactor comprises: at least one cathode plate structured and arranged to provide at least two surfaces of negative electrical charge, and at least one anode plate structured and arranged to provide at least two surfaces positive electrical charge, wherein such hydrogen is produced on at least one of such at least two surfaces of negative electrical charge, and wherein such oxygen is produced on at least one of such at least two surfaces of positive electrical charge; wherein such at least one electrolysis reactor further comprises: at least one parallel-alignment geometry structured and arranged to geometrically-align such at least one cathode plate and such at least one anode plate in a parallel arrangement, at least one edge-alignment geometry structured and arranged to geometrically-align at least one bottom edge of such at least one cathode plate with at least one bottom edge of such at least one anode plate in at least one common plane, and at least one surface-separator structured and arranged to separate such at least one of such at least two surfaces of negative electrical charge from such at least one of such at least two surfaces of positive electrical charge by a fixed separation; wherein such at least one electrolyzer further comprises: at least one number (n) of such at least one anode plates; and at least one plurality (n+1) of such at least one cathode plates; wherein such at least one electrolyzer is further structured and arranged to comprise, in at least one alternating arrangement, such at least one number (n) of such at least one anode plates and such at least one plurality (n+1) of such at least one cathode plates in at least one alternating ordered sequence; wherein such at least one alternating arrangement generates at least one plurality (2n) of such at least one electrolysis reactors; and wherein such at least one surface-separator separates such at least one of such at least two surfaces of negative electrical charge and such at least one of such at least two surfaces of positive electrical charge by about one-seventh of an inch.

Even further, it provides such a system wherein: such at least one number (n) of such at least one anode plates comprises at least six plates; and such at least one plurality (n+1) of such at least one cathode plates comprises at least seven plates; and wherein such at least one cathode plate comprises at least one titanium plate with a width of about five inches and a height of about seven inches; wherein such at least one anode plate comprises at least one titanium plate with width of about five inches and a height of about seven inches; wherein such at least one titanium plate comprises at least one mixed metal oxide coating; and at least one cathode current-transmitter structured and arranged to assist transmission of current between such at least one plurality (n+1) of such at least one cathode plates; and at least one anode current-transmitter-assistor structured and arranged to assist transmission of current between such at least one number (n) of such at least one anode plates; wherein such at least one cathode current-transmitter-assistor comprises at least one titanium pole; and wherein such at least one anode current-transmitter-assistor comprises at least one titanium pole; and at least one water-flow distributor structured and arranged to distribute water flow evenly to each of such at least one plurality of such at least one electrolysis reactors; wherein such at least one water-flow distributor comprises at least one baffle-distributor; and at least water storer structured and arranged to store the water for electrolysis by such at least one electrolyzer; wherein such at least one continuous-flow circulator comprises at least one pump structured and arranged to pump the water between such at least one water storer and such at least one electrolyzer; wherein such at least one pump pumps the water at a flow rate of about three and a half gallons per minute; wherein such at least one water storer comprises at least one water-deliverer structured and arranged to deliver the water to such at least one electrolyzer; wherein such at least one water storer comprises at least one water-receiver structured and arranged to receive un-reacted water and such hydrogen and such oxygen from such at least one electrolyzer; wherein such at least one water storer comprises at least one product separator structured and arranged to separate such hydrogen and such oxygen from such un-reacted water; wherein such at least one water storer comprises at least one product-deliverer structured and arranged to deliver such hydrogen and such oxygen, separated by such at least one product separator, to the at least one internal combustion engine; wherein such at least one reactor-container comprises: at least one water-inlet structured and arranged to provide at least one water-inlet for receiving the water from such at least one water deliverer; at least one cathode-charging aperture structured and arranged to provide an aperture to charge such at least one plurality of such at least one cathode plates; and at least one anode-charging aperture structured and arranged to provide an aperture to charge such at least one number (n) of such at least one anode plates; and at least one co-combustor structured and arranged to co-combust such hydrogen, produced by such at least one electrolyzer, with at least one hydrocarbon fuel source; wherein such co-combustion of such hydrogen with such at least one hydrocarbon fuel source improves the fuel efficiency of the at least one internal combustion engine.

In accordance with another preferred embodiment hereof, this invention provides a system, relating to electrolyzing water, when electrically coupled to at least one electrical source, to provide at least one combustible hydrogen fuel to at least assist fueling at least one internal combustion engine, comprising: at least one electrolyzer structured and arranged to electrolyze the water to produce hydrogen and oxygen; wherein such at least one electrolyzer comprises at least one electrolysis reactor structured and arranged to perform electrolysis reaction with the water; wherein such at least one electrolyzer further comprises at least one directionally-alternating electric field generator structured and arranged to generate at least one directionally-alternating series of electric fields; and at least one continuous-flow circulator structured and arranged to circulate continuous flow of the water through such at least one electrolyzer; and wherein such hydrogen and such oxygen are available to inject in the at least one internal combustion engine to assist fueling the at least one internal combustion engine.

In accordance with another preferred embodiment hereof, this invention provides a system, relating to electrolyzing water, when electrically coupled to at least one electrical source, to provide at least one combustible hydrogen fuel to at least assist fueling at least one internal combustion engine, comprising: electrolyzer means for electrolyzing water to produce hydrogen and oxygen; wherein such electrolyzer means comprises electrolysis reactor means for performing electrolysis reaction with the water; continuous-flow circulator means for circulating continuous flow of the water through such electrolyzer means; wherein such continuous-flow circulator means comprises product sweeper means for sweeping such hydrogen and such oxygen through such electrolysis reactor means; and wherein such hydrogen and such oxygen are available to inject in the at least one internal combustion engine to assist fueling the at least one internal combustion engine.

In addition, this invention provides and every novel feature, element, combination, step and/or method disclosed or suggested by this patent application.

### BRIEF DESCRIPTION OF THE DRAWINGS

FIG. 1 shows a diagrammatic view, illustrating a hydrogen fuel system, according to the preferred embodiment of the present invention.

FIG. 2 shows a perspective view, illustrating an electrolysis chamber of the hydrogen fuel system, according to the preferred embodiment of FIG. 1.

FIG. 3 shows an exploded view, illustrating a housing of an electrolysis chamber, according to the preferred embodiment of FIG. 1.

FIG. 4 shows an exploded view, illustrating a housing and a lid of an electrolysis chamber of the hydrogen fuel system, according to an alternately preferred embodiment of the present invention.

FIG. 5A shows a perspective view of a baffle unit of the hydrogen fuel system, according to the preferred embodiment of FIG. 1.

FIG. 5B shows a top view of the baffle unit, according to the preferred embodiment of FIG. 5A.

FIG. 5C shows a sectional view through the section 5-5 of FIG. 5B, according to the preferred embodiment of FIG. 5A.

FIG. 6A show a top view, illustrating the arrangement of electrode plates of the hydrogen fuel system, according to the preferred embodiment of FIG. 1.

FIG. 6B shows a side view, illustrating electrical connectivity between cathode plates, according to the preferred embodiment of FIG. 6A.

FIG. 6C shows a side view, illustrating electrical connectivity between anode plates, according to the preferred embodiment of FIG. 6A.

FIG. 6D shows a perspective view, illustrating a bracket and a terminal, according to the preferred embodiment of FIG. 6A.

FIG. 6E shows a perspective view, illustrating a bracket and a negative terminal, according to the preferred embodiment of FIG. 6A.

FIG. 6F shows a side view, illustrating the alignment of electrode plates with aligning bolts and the separation of electrode plates with non-conducting washers, according to the preferred embodiment of FIG. 6A.

FIG. 7 shows a front view, illustrating an electrolysis plate, according to the preferred embodiment of FIG. 1.

FIG. 8A shows a side view, illustrating a water tank, according to the preferred embodiment of FIG. 1.

FIG. 8B shows a top view, illustrating the water tank, according to the preferred embodiment of FIG. 8A.

FIG. 8C shows a bottom view, illustrating the water tank, according to the preferred embodiment of FIG. 8A.

FIG. 9 shows a diagrammatic exploded view, illustrating at least one pole assembly, according to a preferred embodiment of the present invention.

FIG. 10A shows a perspective view, illustrating an alternately preferred housing, according to a preferred embodiment of the present invention.

FIG. 10B shows a side view, illustrating an alternately preferred dual stacked array, according to the preferred embodiment of FIG. 10A.

### DETAILED DESCRIPTION OF THE BEST MODES AND PREFERRED EMBODIMENTS OF THE INVENTION

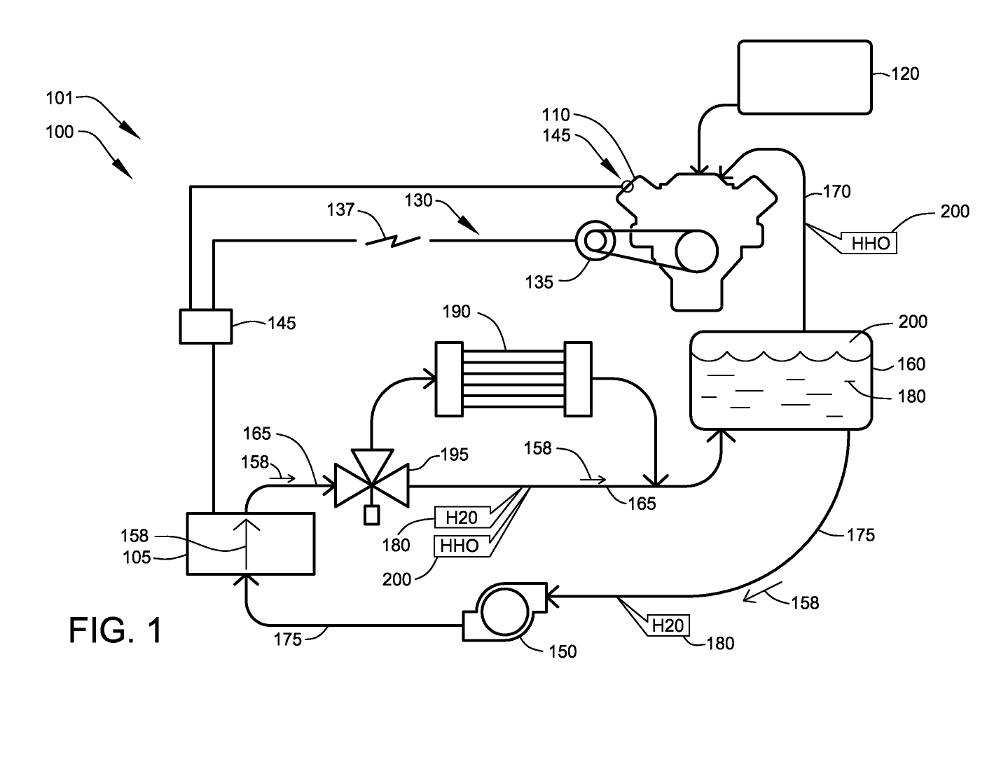

FIG. 1 shows a diagrammatic view, illustrating hydrogen fuel system 100, according to the preferred embodiment of the present invention. Hydrogen fuel system 100 preferably comprises internal combustion engine 110, hydrocarbon fuel source 120, and electrolysis chamber 105, as shown. Hydrogen fuel system 100 preferably is designed to co-combust hydrocarbon fuel source 120 and hydrogen gas generated in electrolysis chamber 105. Hydrogen fuel system 100 preferably utilizes the energy generated from the co-combustion of hydrocarbon fuel source 120 and hydrogen gas to operate an automobile. Upon reading the teachings of this specification, those skilled in the art will now appreciate that, under appropriate circumstances, considering such issues as cost, future technologies, etc., other combustion driven machinery, such as, for example, pumps, tractors, construction machinery, mining machinery, other heavy machinery, etc., may suffice.

Internal combustion engine 110 preferably comprises a diesel engine. Upon reading this specification, those with ordinary skill in the art will now appreciate that, under appropriate circumstances, considering such issues as design preference, user preferences, cost, changing needs, future technologies, etc., other engine types such as, for example, gasoline-burning engines, biodiesel fuel-burning engines, other types of fuel burning engines, etc., may suffice.

Electrolysis chamber 105 (at least embodying herein at least one electrolyzer structured and arranged to electrolyze the water to produce hydrogen and oxygen; and at least embodying herein electrolyzer means for electrolyzing water to produce hydrogen and oxygen) preferably performs water splitting, generating two moles of hydrogen (H₂) and one mole of oxygen (O₂) from two moles of water. The product of the water splitting reaction performed by electrolysis chamber 105 is also referred to as Brown's gas 200, and is represented as HHO, as shown. Hydrogen fuel system 100 preferably is designed to feed Brown's gas 200 to internal combustion engine 110, as shown, preferably through at least one air intake manifold. Upon reading the teachings of this specification, those skilled in the art will now appreciate that, under appropriate circumstances, considering such issues as cost, implementation timing, future technologies, etc., other Brown's gas introduction methods, such as, for example, injecting mixed with fuel, carburetor injection, pressurized injection, etc., may suffice.

Once injected into internal combustion engine 110, hydrogen gas in Brown's gas 200 preferably is co-combusted with fuel from hydrocarbon fuel source 120 in the presence of air. The product of hydrogen gas combustion in internal combustion engine 110 is water.

Internal combustion engine 110 preferably utilizes hydrocarbon fuel source 120 as a primary source of fuel, and hydrogen gas generated in electrolysis chamber 105 as a supplemental fuel source. The co-combustion of fuel from hydrocarbon fuel source 120 with hydrogen gas generated in electrolysis chamber 105 preferably leads to an increase in fuel efficiency of hydrocarbon fuel source 120 (see details below). Furthermore, the co-combustion of hydrocarbon fuel source 120 in the presence of supplemental hydrogen preferably leads to a decrease in pollutant emissions from internal combustion engine 110.

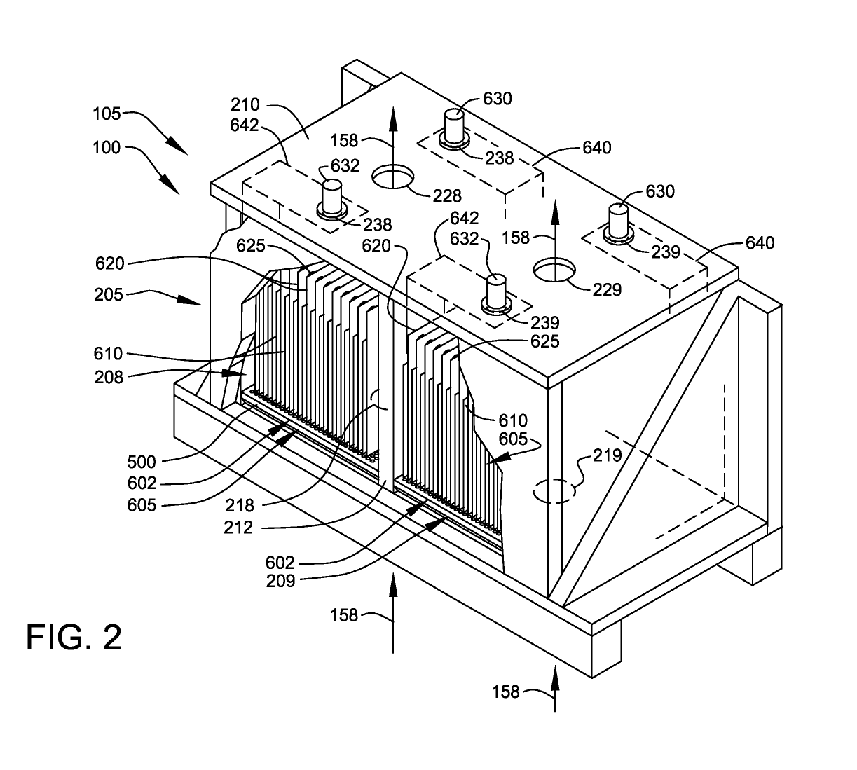

Internal combustion engine 110 preferably provides energy to alternator 135, as shown. Alternator 135 preferably converts mechanical energy, preferably provided by internal combustion engine 110, into electrical energy 137. Electrical energy 137 generated by alternator 135 preferably is used to power electrical system 130, preferably of such automobile or such other piece of machinery, as shown. In addition, electrolysis chamber 105 preferably is structured and arranged to harness electrical energy 137 generated by alternator 135 to drive the process of water splitting and generation of Brown's gas 200, as shown (see further details below). More specifically, electrolysis chamber 105 preferably utilizes current from electrical system 130 to charge at least one electrode plate 605 (see FIG. 2) in order to drive electrolysis (see further details below). Electrolysis chamber 105 preferably operates at a current of about thirty to about sixty amperes. Upon reading this specification, those with ordinary skill in the art will now appreciate that, under appropriate circumstances, considering such issues as design preference, cost, future technologies, etc., other current inputs such as, for example, higher current inputs, lower current inputs, etc., may suffice.

Hydrogen fuel system 100 further preferably comprises at least one water tank 160, as shown. Water tank 160 (at least embodying herein at least one water storer structured and arranged to store the water for electrolysis by such at least one electrolyzer) preferably is in fluid communication with electrolysis chamber 105, as shown. Water tank 160 preferably stores water 180, preferably liquid water, for use in electrolysis reactions performed in electrolysis chamber 105. Water tank 160 preferably provides water 180 to electrolysis chamber 105 through at least one water conduit 175 (at least herein embodying wherein such at least one water storer comprises at least one water-deliverer structured and arranged to deliver the water to such at least one electrolyzer), as shown. Water conduit 175 preferably comprises tubing, preferably vinyl tubing, preferably vinyl tubing with an inner diameter of about one-half inch. Upon reading this specification, those with ordinary skill in the art will now appreciate that, under appropriate circumstances, considering such issues as design preference, manufacturer preference, cost, future technologies, etc., other conduits, such as, for example, other types of tubing, pipes, channels, etc., may suffice. Upon reading the teachings of this specification, those skilled in the art will now appreciate that, under appropriate circumstances, considering such issues as future technologies, cost, available materials, etc., other conduit materials, such as, for example, rubber, stainless steel, other plastics, plastic lined steel, etc., may suffice.

Hydrogen fuel system 100 preferably comprises at least one water pump 150, as shown. Water pump 150 (at least embodying herein continuous-flow circulator means for circulating continuous flow of the water through such electrolyzer means; and at least embodying herein at least one continuous-flow circulator structured and arranged to circulate continuous flow of the water through such at least one electrolyzer) preferably continuously pumps water 180 from water tank 160 to electrolysis chamber 105, through electrolysis chamber 105, and back to water tank 160, as shown by flow direction 158.

Water pump 150 preferably pumps water 180 at a flow rate of about three and a half gallons per minute. Upon reading this specification, those with ordinary skill in the art will now appreciate that, under appropriate circumstances, considering such issues as design preference, cost, future technologies, etc., other water flow rates such as, for example, higher water flow rates, lower water flow rates, etc., may suffice.

Water pump 150 preferably comprises a diaphragm water pump, preferably a four diaphragm water pump, preferably a relay controlled four-diaphragm water pump. Upon reading this specification, those with ordinary skill in the art will now appreciate that, under appropriate circumstances, considering such issues as design preference, cost, manufacturer preference, future technologies, etc., other water pump types, such as, for example, rotary-type pumps, gear pumps, peristaltic pumps, trash pumps, other positive displacement pumps, etc., may suffice.

Brown's gas 200 generated in electrolysis chamber 105 preferably is pumped to water tank 160 through at least one product conduit 165 (at least herein embodying wherein such at least one water storer comprises at least one water-receiver structured and arranged to receive both un-reacted water and such hydrogen and such oxygen, from such at least one electrolyzer), as shown. Product conduit 165 preferably comprises tubing, preferably vinyl tubing with an inner diameter of about one-half inch. Upon reading this specification, those with ordinary skill in the art will now appreciate that, under appropriate circumstances, considering such issues as design preference, manufacturer preference, cost, future technologies, etc., other conduits, such as, for example, other types of plastic tubing, pipes, conduits with other diameters, channels, etc., may suffice. Upon reading the teachings of this specification, those skilled in the art will now appreciate that, under appropriate circumstances, considering such issues as future technologies, cost, available materials, etc., other conduit materials, such as, for example, rubber, stainless steel, other plastics, plastic lined steel, etc., may suffice.

Brown's gas 200 preferably is carried to water tank 160 in water 180, as shown. Water tank 160 preferably assists separation of received Brown's gas 200 from water 180 by gas-liquid phase separation, as shown (this arrangement at least herein embodying wherein such at least one water storer comprises at least one product separator structured and arranged to separate such hydrogen and such oxygen from such un-reacted water). Water tank 160 preferably recycles water 180 collected from electrolysis chamber 105 back to electrolysis chamber 105 through water conduit 175 for subsequent electrolysis reactions.

The separated Brown's gas 200 preferably is fed from water tank 160 into internal combustion engine 110 through hydrogen fuel conduit 170 (at least herein embodying wherein such at least one water storer comprises at least one product-deliverer structured and arranged to deliver such hydrogen and such oxygen, separated by such at least one product separator, to the at least one internal combustion engine), as shown. Brown's gas 200 preferably is vacuum-drawn into internal combustion engine 110 by a vacuum generated in the at least one air intake manifold of internal combustion engine 110. Hydrogen fuel conduit 170 preferably comprises tubing, preferably vinyl tubing with an inner diameter of about one-half inch. Upon reading this specification, those with ordinary skill in the art will now appreciate that, under appropriate circumstances, considering such issues as design preference, manufacturer preference, cost, future technologies, etc., other conduits, such as, for example, other types of plastic tubing, pipes, conduits of other diameters, etc., may suffice. Upon reading the teachings of this specification, those skilled in the art will now appreciate that, under appropriate circumstances, considering such issues as future technologies, cost, available materials, etc., other conduit materials, such as, for example, rubber, stainless steel, other plastics, plastic lined steel, etc., may suffice.

Hydrogen fuel system 100 preferably further comprises at least one radiator unit 190, as shown. Radiator unit 190 preferably maintains the temperature of water 180 of hydrogen fuel system 100 at about forty degrees Celsius. At least one thermostatically-activated valve 195 preferably directs water 180 flowing through product conduit 165 to radiator unit 190 when the temperature of water 180 rises above about forty degrees Celsius, in order to cool water 180. Upon reading this specification, those with ordinary skill in the art will now appreciate that, under appropriate circumstances, considering such issues as design preference, cost, manufacturer preference, future technologies, etc., other temperatures, such as, for example, higher temperatures, lower temperatures, etc., may suffice. Upon reading the teachings of this specification, those skilled in the art will now appreciate that, under appropriate circumstances, considering such issues as future technologies, cost, etc., other temperature regulators, such as, for example, thermoelectric units, isolated thermal-fluid circuits, coaxial conduits, other heat exchangers, etc., may suffice.

Hydrogen fuel system 100 preferably further comprises at least one controller unit 140, as shown. Controller unit 140 preferably controls the rate of production of Brown's gas 200 in electrolysis chamber 105. Controller unit 140 preferably utilizes at least one engine sensor 145, preferably at least one engine speed sensor, preferably at least one revolutions-per-minute (RPM) sensor. Controller unit 140 preferably additionally utilizes at least one current draw sensor. Controller unit 140 preferably regulates electrical activity of each cell in electrolysis chamber 105, preferably turning each cell on or off according to need as determined through current draw and engine sensor 145, preferably according to fuel consumption preferably determinable through engine speed.

Water 180 preferably continuously flows through electrolysis chamber 105 according to the pumping action of water pump 150, as shown. This arrangement preferably assists preventing the accumulation of generated hydrogen gas and oxygen gas on the surfaces of electrode plates 605 (see FIG. 2) within electrolysis chamber 105 (see further details below). The continuous pumping action of water pump 150 preferably assists forcing the formed Brown's gas 200 into water tank 160 for subsequent delivery to internal combustion engine 110, as shown. This arrangement at least herein embodies wherein such continuous-flow circulator means comprises product sweeper means for sweeping such hydrogen and such oxygen through such electrolysis reactor means; and this arrangement at least herein embodies wherein such at least one continuous-flow circulator comprises at least one product sweeper structured and arranged to sweep such hydrogen and such oxygen through such at least one electrolysis reactor.

Once transferred into internal combustion engine 110, the hydrogen gas in Brown's gas 200 preferably is combusted in the presence of air forming water. This process along with the co-combustion of hydrocarbon fuel source 120 in internal combustion engine 110 preferably releases energy used to operate such at least one automobile. Applicant theorizes that the combustion of hydrogen gas in internal combustion engine 110 leads to increased temperatures in internal combustion engine 110, resulting in an increased consumption of hydrocarbon fuel source 120 and an overall increase in fuel efficiency. Applicant has determined, through testing, an increase of about thirty-five percent in fuel efficiency of internal combustion engine 110 due to the co-combustion with hydrogen gas.

Hydrogen fuel system 100 preferably consumes about one gallon of water per one-thousand miles of use in a diesel engine vehicle. Upon reading this specification, those with ordinary skill in the art will now appreciate that, under appropriate circumstances, considering such issues as design preference, cost, future technologies, etc., other water consumption rates such as, for example, higher consumption rates, lower consumption rates, etc., may suffice.

Water 180 consumed by hydrogen fuel system 100 preferably comprises distilled water. Upon reading this specification, those with ordinary skill in the art will now appreciate that, under appropriate circumstances, considering such issues as design preference, cost, manufacturer preference, future technologies, etc., other water-based solutions, such as, for example, water containing electrolytes, etc., may suffice.

FIG. 2 shows a perspective view, illustrating electrolysis chamber 105 of hydrogen fuel system 100, according to the preferred embodiment of FIG. 1. More detailed descriptions of each component of electrolysis chamber 105 will be provided below. Electrolysis chamber 105 preferably comprises at least one housing 205 (at least herein embodying wherein such at least one electrolyzer further comprises at least one reactor-container structured and arranged to contain such at least one electrolysis reactor) and at least one lid 210, as shown. In use, lid 210 preferably seals with housing 205, preferably utilizing a series of bolts and at least one gasket. Housing 205 and lid 210 preferably are comprised of non-conductive material, preferably plastic, preferably polypropylene plastic. Upon reading this specification, those with ordinary skill in the art will now appreciate that, under appropriate circumstances, considering such issues as design preference, manufacturer preference, cost, future technologies, etc., other materials, such as, for example, polyethylene, nylon, other plastics, other non-conductive materials, etc., may suffice.

Electrolysis chamber 105 preferably comprises at least two isolated chambers, left chamber 208 and right chamber 209, as shown. Left chamber 208 and right chamber 209 preferably are separated by at least one wall 212, as shown. Left chamber 208 and right chamber 209 preferably each comprise an isolated reaction chamber for generation of Brown's gas 200 (see further details below). Upon reading this specification, those with ordinary skill in the art will now appreciate that, under appropriate circumstances, considering such issues a design preference, manufacturer preferences, cost, future technologies, etc., other electrolysis chamber arrangements, such as, for example, more chambers, fewer chambers, sequential chambers, etc., may suffice.

Left chamber 208 and right chamber 209 preferably are each structured and arranged to contain a plurality of electrode plates 605, as shown, which preferably perform electrolysis of water 180 (see details below). The plurality of electrode plates 605 preferably are aligned in at least one stacked array 602 in which the planar charged surfaces of electrode plates 605 preferably are fully overlapped, as shown (see details below). Electrode plates 605 preferably comprise at least one anode plate 620 (at least embodying herein at least one anode plate structured and arranged to provide at least two surfaces of positive electrical charge) and at least one plurality of cathode plates 610. Each cathode plate 610 (at least embodying herein at least one cathode plate structured and arranged to provide at least two surfaces of negative electrical charge) preferably comprises two planar surfaces of negative electrical charge and each anode plate 620 preferably comprises two surfaces of positive electrical charge.

The plurality of electrode plates 605 in stacked array 602 preferably are arranged to maximize the surface-area of overlap of positive electrical charge and negative electrical charge between each pair of electrode plates 605, as shown. This arrangement preferably generates a sequence of directionally alternating electric fields. This arrangement at least herein embodies wherein such at least one electrolyzer further comprises at least one directionally-alternating electric field generator structured and arranged to generate at least one directionally-alternating series of electric fields.

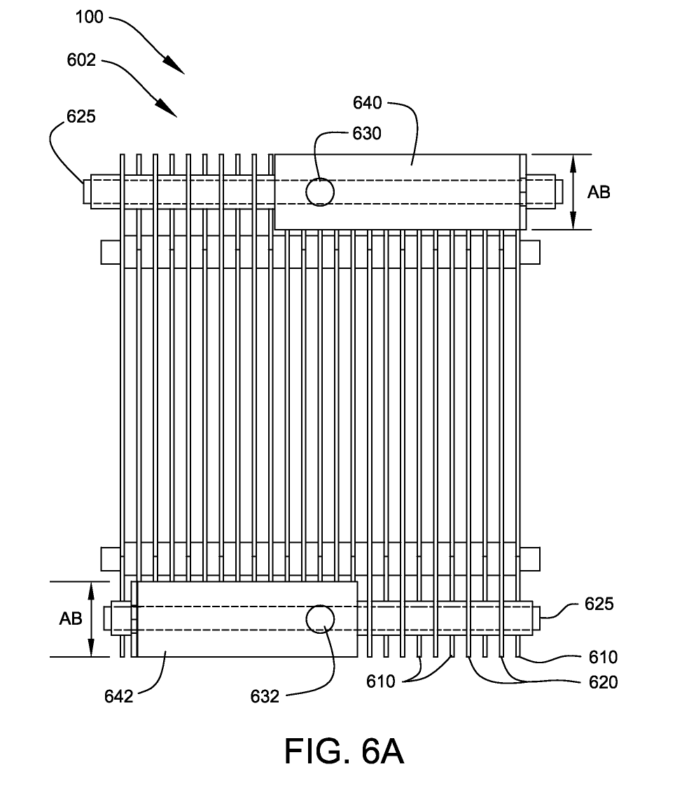

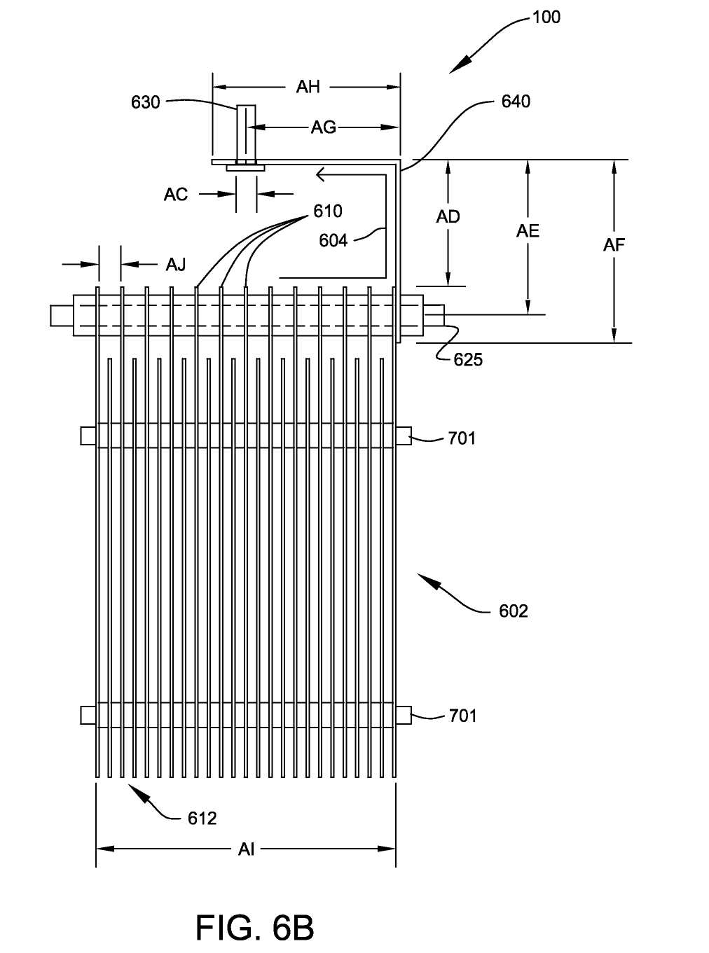

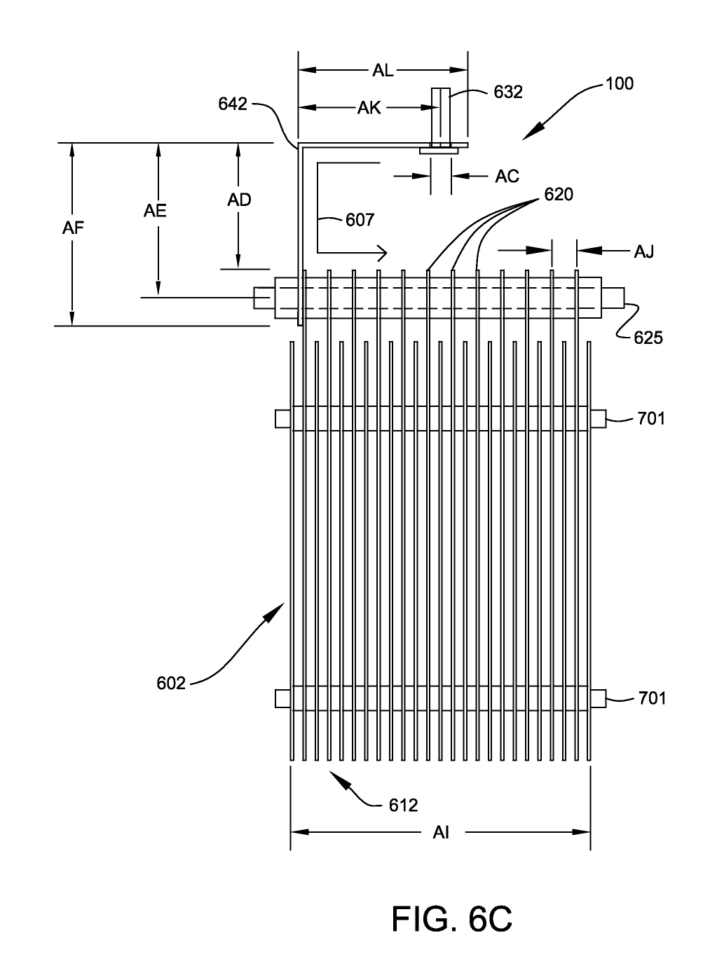

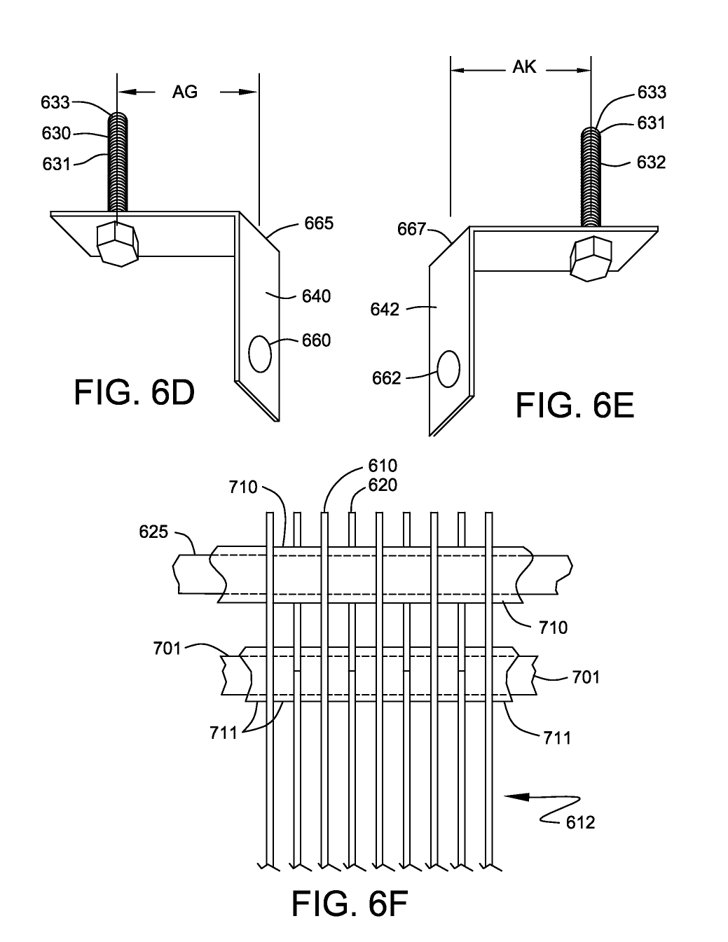

Stacked array 602 of electrode plates 605 preferably comprises an alternating sequence of (n) anode plates 620 and (n+1) cathode plates 610 (see details below). A preferred embodiment of the present invention preferably utilizes twelve anode plates 620 stacked with thirteen cathode plates 610 arranged in an alternating sequence (see FIG. 6A to FIG. 6D). Upon reading this specification, those with ordinary skill in the art will now appreciate that, under appropriate circumstances, considering such issues as design preference, cost, manufacturer preference, future technologies, etc., other electrode plate arrangements such as, for example, a non-alternating stacked arrangement, an offset stacked arrangement, incorporation of neutral electrode plates, more plates, fewer plates, etc., may suffice.

Left chamber 208 preferably comprises at least one left water inlet aperture 218, as shown. Left water inlet aperture 218 preferably is connected to water conduit 175 to supply water 180 to left chamber 208. Left water inlet aperture 218 preferably is sealed to water conduit 175 by at least one seal in order to prevent leakage of water 180. Right chamber 209 preferably correspondingly comprises at least one right water inlet aperture 219, as shown. Right water inlet aperture 219 preferably is also connected to water conduit 175 to supply water 180 to right chamber 209. Right water inlet aperture 219 preferably is sealed to water conduit 175 by at least one seal in order to prevent leakage of water 180.

Left chamber 208 and right chamber 209 each preferably comprise at least one baffle unit 500, as shown. Baffle unit 500 (at least embodying herein at least one water-flow distributor structured and arranged to distribute water flow evenly to each of such at least one plurality of such at least one electrolysis reactors) preferably is positioned beneath stacked array 602 in order to provide an even flow distribution of water 180 over the surfaces of electrode plates 605 (see further details below).

Left chamber 208 preferably comprises at least one left product outlet aperture 228, as shown. Left product outlet aperture 228 preferably provides an outlet for release of Brown's gas 200 generated in left chamber 208. Left product outlet aperture 228 preferably is connected to product conduit 165, allowing Brown's gas 200 and water 180 to be transferred to water tank 160 (see FIG. 1). Left product outlet aperture 228 preferably is sealed to product conduit 165 using at least one seal to prevent leakage of Brown's gas 200 and water 180.

Right chamber 209 preferably comprises at least one right product outlet aperture 229, as shown. Right product outlet aperture 229 preferably provides an outlet for release of Brown's gas 200 generated in right chamber 209. Right product outlet aperture 229 preferably is also connected to product conduit 165, preferably allowing Brown's gas 200 and water 180 to preferably flow from right chamber 209 into water tank 160 (see FIG. 1). Right product outlet aperture 229 preferably is sealed to product conduit 165 using at least one seal to prevent leakage of Brown's gas 200 and water 180.

Water 180 preferably flows through electrolysis chamber 105 according to flow direction 158, as shown. Brown's gas 200 preferably exits electrolysis chamber 105 according to flow direction 158, as shown. Water 180 preferably enters electrolysis chamber 105 through water inlet aperture 218 (or water inlet aperture 219) preferably passes through baffle unit 500, according to flow direction 158, as shown. Baffle unit 500 preferably evenly distributes the flow of water 180 across the surfaces of electrode plates 605 in stacked array 602. On the surfaces of electrode plates 605, some water 180 preferably is split to generate Brown's gas 200. The generated Brown's gas 200 preferably is carried out of electrolysis chamber 105 in water 180 through left product outlet aperture 228 (or right product outlet aperture 229), according to flow direction 158, as shown.

Left chamber 208 preferably comprises at least one terminal 630 and at least one terminal 632, as shown. Terminal 630 and terminal 632 preferably protrude out from electrolysis chamber 105 through one of left charging apertures 238 located on lid 210, as shown. Terminal 630 preferably is in electrical communication with controller unit 140 (see FIG. 1) and cathode plates 610 (see FIG. 6B) housed in electrolysis chamber 105. Electrical system 130 preferably provides electrical charge to cathode plates 610, via controller unit 140, through terminal 630 (see further details below). Terminal 632 preferably is in electrical communication controller unit 140 and with anode plates 620 housed in electrolysis chamber 105 (see FIG. 6C). Electrical system 130 preferably provides charge to anode plates 620, via controller unit 140, through terminal 632 (see further details below).

Right chamber 209 preferably comprises at least one terminal 630 and at least one terminal 632, as shown. Terminal 630 and terminal 632 preferably protrude from electrolysis chamber 105 through right charging apertures 239 located on lid 210, as shown. Electrical system 130 preferably provides charge to cathode plates 610 and anode plates 620, via controller unit 140, through terminal 630 and terminal 632, respectively (see further details below).

Terminals 630 and terminals 632 preferably comprise conductive bolts, preferably titanium conductive bolts, preferably titanium conductive bolts with twenty threads per inch (see further details below). Upon reading this specification, those with ordinary skill in the art will now appreciate that, under appropriate circumstances, considering such issues as design preference, manufacturer preference, cost, future technologies, etc., other terminal material arrangements, such as, for example, brass terminals, copper terminals, other terminals comprised of other conductive materials, etc., may suffice.

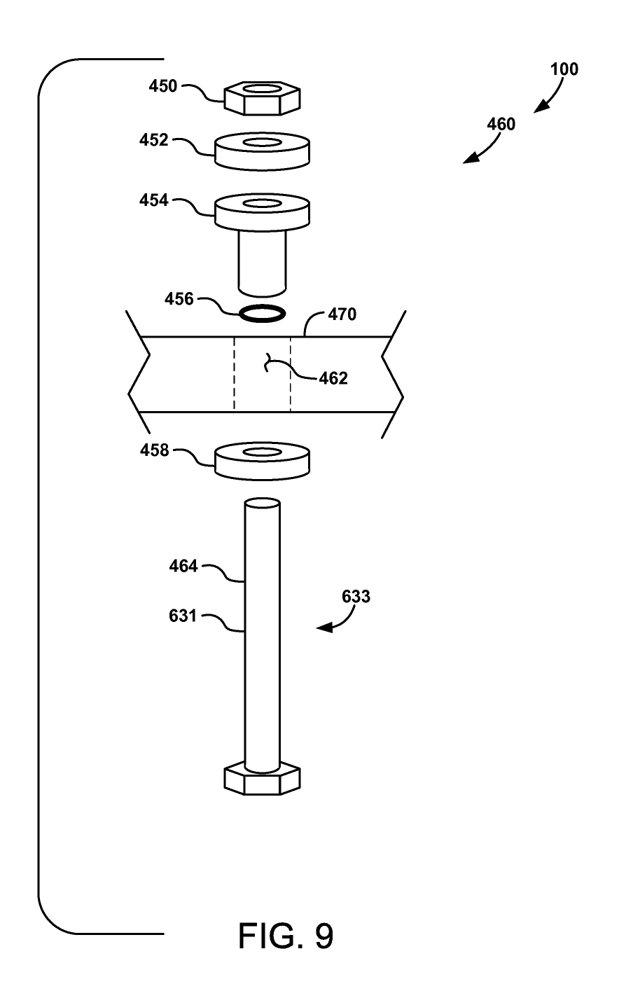

The space between each of left charging apertures 238 (or each of right charging apertures 239) and each of terminals 630 and terminals 632 preferably is sealed by at least one non-conductive sleeve with a high melting point, preferably at least one nylon sleeve with suitable dimensions (see FIG. 9). This arrangement preferably assists preventing terminals 630 and terminals 632 from coming into contact with, and possibly melting, lid 210. Terminals 630 and terminals 632 preferably are further tightened in position with at least one nut, at least one titanium flat washer, at least one silicon o-ring, and at least one nylon flat washer (see FIG. 9). This arrangement preferably tightens terminals 630 and terminals 632 in position, and preferably seals the system, preventing water leakage.

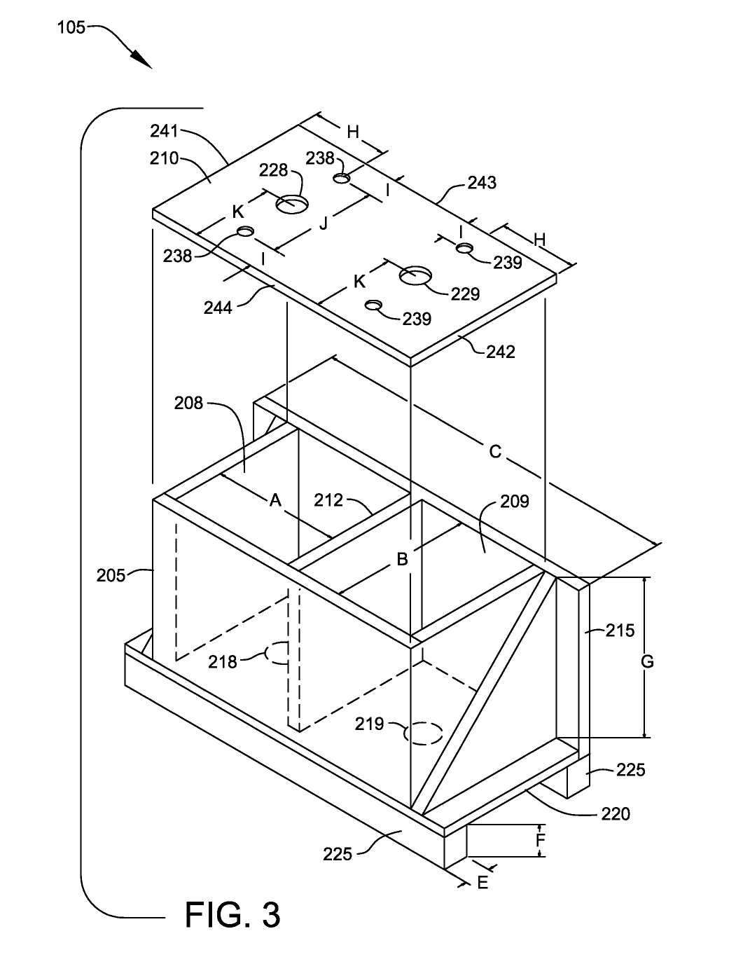

FIG. 3 shows an exploded view, illustrating housing 205 and lid 210 of electrolysis chamber 105, according to the preferred embodiment of FIG. 1. Left chamber 208 and right chamber 209 each preferably have a length of about five inches (about 12.7 centimeters [cm]) and a width of about six inches (about 15¼ cm), as shown by dimensions A and B, respectively. In addition, left chamber 208 and right chamber 209 each preferably have a depth of about nine inches (about 23 cm), as shown by dimension G. Upon reading this specification, those with ordinary skill in the art will now appreciate that, under appropriate circumstances, considering such issues as design preference, cost, manufacturer preference, future technologies, etc., other chamber dimension arrangements such as, for example, other widths, other lengths, other depths, other shapes, etc., may suffice.

Housing 205 preferably comprises a wall-thickness of about one-half of an inch (about 1¼ cm). Upon reading this specification, those with ordinary skill in the art will now appreciate that, under appropriate circumstances, considering such issues as design preference, cost, manufacturer preference, future technologies, etc., other chamber wall thickness arrangements, such as, for example, thinner, thicker, etc., may suffice.

Left water-inlet aperture 218 and right water-inlet aperture 219 each preferably comprise a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other diameters, such as, for example, smaller diameters, larger diameters, etc., may suffice.

Housing 205 preferably comprises at least one back panel 215, as shown. Back panel 215 preferably has a length of about fifteen inches (about 38 cm), as shown by dimension C. Housing 205 preferably further comprises at least one base panel 220 which preferably forms the structural base of housing 205, as shown. Base panel 220 preferably is supported by at least two legs 225, as shown. Each leg 225 preferably comprises a width of about one inch (about 2.5 cm) and a height of about two inches (about 5 cm), as shown by dimensions E and F, respectively. Upon reading this specification, those with ordinary skill in the art will now appreciate that, under appropriate circumstances, considering such issues as design preference, cost, manufacturer preference, future technologies, etc., other chamber leg dimensional arrangements, such as, for example, shorter legs, taller legs, thicker legs, absence of chamber legs, etc., may suffice.

Lid 210 of electrolysis chamber 105 preferably comprises at least two left charging apertures 238 and at least two right charging apertures 239, as shown. Left charging apertures 238 and right charging apertures 239 preferably provide passages for terminals 630 and terminals 632 to extend externally from left chamber 208 and right chamber 209, respectively (see FIG. 2). This arrangement permits charging of electrode plates 605 held within left chamber 208 and right chamber 209. Left charging apertures 238 and right charging apertures 239 each preferably comprise a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other diameters, such as, for example, smaller diameters, larger diameters, etc., may suffice.

Left charging apertures 238 preferably are located about three inches (about 7⅝ cm) from left edge 241 of lid 210, as shown by dimension H in FIG. 3. One left charging aperture 238 preferably is located about one and one-eighths inches (about ⅜ cm) from upper edge 243 of lid 210, and the other left charging aperture 238 preferably is located one and one-eighths inches (about 2⅞ cm) from lower edge 244 of lid 210, as shown by dimension I in FIG. 3. Left charging apertures 238 preferably are spaced apart by about four inches (about 10 cm), as shown by dimension J in FIG. 2. Upon reading this specification, those with ordinary skill in the art will now appreciate that, under appropriate circumstances, considering such issues as design preference, cost, manufacturer preference, future technologies, etc., other aperture spacing arrangement, such as, for example, larger spacings, smaller spacings, etc., may suffice.

Likewise, right charging apertures 239 preferably are located about three inches (about 7⅝ cm) from right edge 242 of lid 210, as shown by dimension H in FIG. 3. One right charging aperture 239 preferably is located about one and one-eighths inches (about 2⅞ cm) from upper edge 243, and the other right charging aperture 239 preferably is located about one and one-eighths inches (about 2⅞ cm) from lower edge 244, as shown by dimension I in FIG. 2. Right charging apertures 239 preferably are spaced apart by about four inches (about 10 cm), as shown by dimension J. Upon reading this specification, those with ordinary skill in the art will now appreciate that, under appropriate circumstances, considering such issues as design preference, cost, manufacturer preference, future technologies, etc., other aperture spacing arrangement, such as, for example, larger spacings, smaller spacings, etc., may suffice.

Lid 210 preferably comprises at least one left product outlet aperture 228 and at least one right product outlet aperture 229, as shown. Left product outlet aperture 228 and right product outlet aperture 229 each preferably comprise a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other diameters, such as, for example, smaller diameters, larger diameters, etc., may suffice.

Left product outlet aperture 228 and right product outlet aperture 229 preferably are located about three inches (about 7⅝ cm) from left edge 241 and right edge 242 of lid 210, respectively, as shown by dimension H in FIG. 3. Left product outlet aperture 228 and right product outlet aperture 229 preferably are located about three inches (about 7⅝ cm) from lower edge 244 of lid 210, as shown by dimension K in FIG. 3.

FIG. 4 shows an exploded view, illustrating housing 405 and lid 410 of electrolysis chamber 305 of hydrogen fuel system 100, according to an alternately preferred embodiment of the present invention. While many features of electrolysis chamber 305 are repeated from electrolysis chamber 105, electrolysis chamber 305 preferably comprises one reaction chamber 408 for performing electrolysis reactions, as shown.

Electrolysis chamber 305 preferably comprises at least one housing 405 and at least one lid 410, as shown. In use, lid 410 preferably is sealed to housing 405, preferably utilizing a series of bolts and at least one gasket. Housing 405 preferably comprises back panel 415 and base panel 420, as shown. In addition, housing 405 preferably comprises water inlet aperture 418, as shown. Water inlet aperture 418 preferably is structured and arranged to receive water conduit 175, preferably allowing water 180 to flow from water tank 160 into electrolysis chamber 305 (see FIG. 1). Water conduit 175 preferably is sealed to water inlet aperture 418 preferably using at least one seal to prevent leakage of water 180. Water inlet aperture 418 preferably comprises a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other diameters, such as, for example, smaller diameters, larger diameters, etc., may suffice.

Reaction chamber 408 preferably is structured and arranged to contain stacked array 602 and baffle unit 500 (see FIG. 2). Reaction chamber 408 preferably comprises a length of about five inches (about 12.7 cm), and a width of about six inches (about 15¼ cm), as shown by dimensions N and O, respectively. Reaction chamber 408 preferably comprises a depth of about nine inches (about 23 cm), as shown by dimension P.

Lid 410 preferably comprises a length of about six inches (about 15¼ cm) and a width of about six and a half inches (about 16½ cm), as shown by dimensions Q and R, respectively. Upon reading this specification, those with ordinary skill in the art will now appreciate that, under appropriate circumstances, considering such issues as design preference, cost, manufacturer preference, future technologies, etc., other lid dimensions, such as, for example, other lengths, other widths, other lid thicknesses, other lid shapes, etc., may suffice.

Lid 410 preferably comprises at least two charging apertures 438, as shown. Charging apertures 438 preferably provide passages to permit terminal 630 and terminal 632 (see FIG. 2) to extend externally from electrolysis chamber 305 in order to permit charging of electrode plates 605 contained in reaction chamber 408 (see further details below). Charging apertures 438 preferably comprise a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other diameters, such as, for example, smaller diameters, larger diameters, etc., may suffice.

Charging apertures 438 preferably are located about three inches (about 7⅝ cm) from left edge 441 of lid 410 and about three inches (about 7⅝ cm) from right edge 442, as shown by dimension S. In addition, one charging aperture 438 preferably is located about one and one-eighths inches (about 2⅞ cm) from upper edge 443 of lid 410, and the other charging aperture 438 preferably is located about one and one-eighths inches (about 2⅞ cm) from lower edge 444 of lid 410, as shown by dimension T.

Lid 410 further preferably comprises at least one product outlet aperture 428, as shown. Product outlet aperture 428 preferably provides an outlet for Brown's gas 200 generated in reaction chamber 405 to be delivered to water tank 160 through product conduit 165 (see FIG. 1). Product conduit 165 preferably is sealed to product outlet aperture 428 using at least one seal to prevent leakage of water 180 and Brown's gas from electrolysis chamber 305. Product outlet aperture 428 preferably is centrally located on lid 410, as shown. Product outlet aperture 428 preferably comprises a diameter of about three-eighths of an inch (about ⅞ cm). Upon reading this specification, those with ordinary skill in the art will now appreciate that, under appropriate circumstances, considering such issues as design preference, cost, manufacturer preference, future technologies, etc., other outlet aperture locations and dimensions, such as, for example, smaller diameters, larger diameters, other aperture shapes, other aperture locations, etc., may suffice.

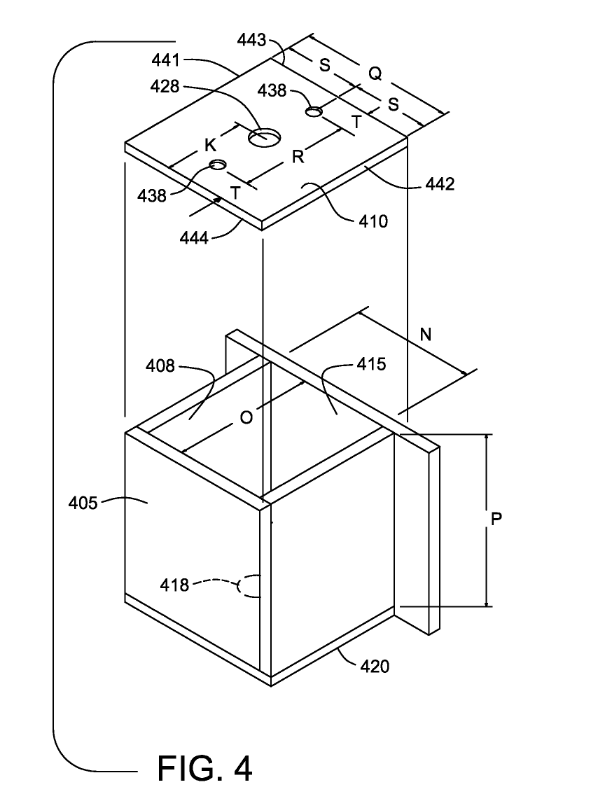

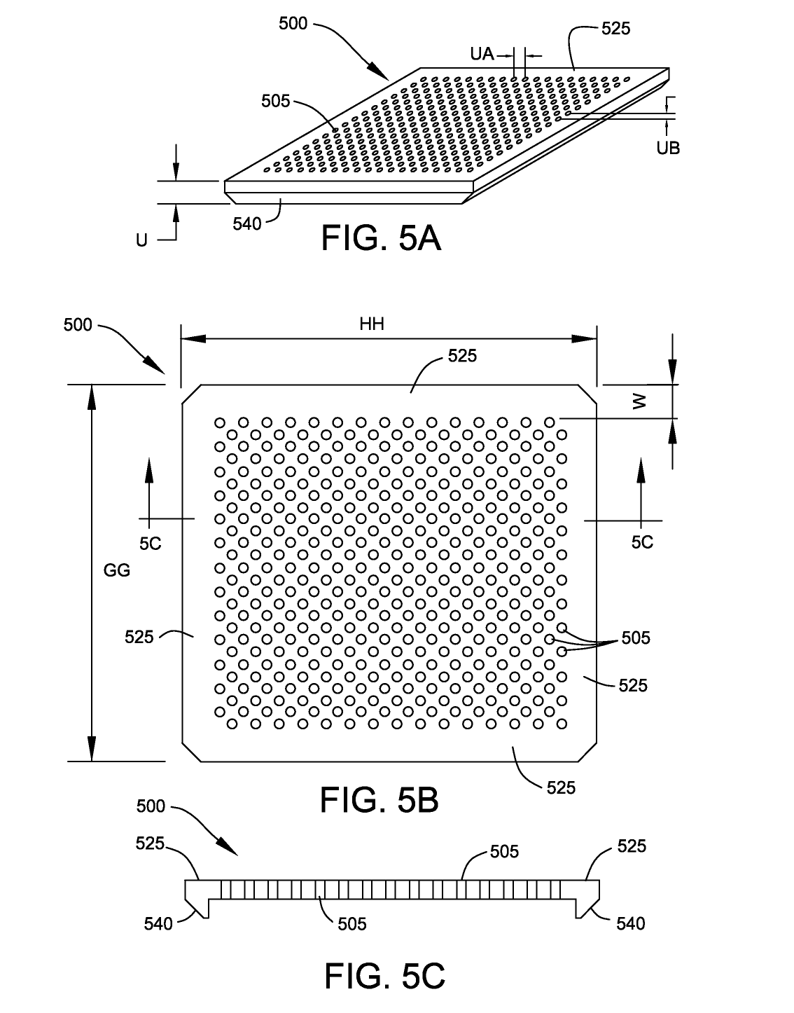

FIG. 5A shows a perspective view of baffle unit 500 of hydrogen fuel system 100, according to the preferred embodiment of FIG. 1. FIG. 5B shows a top view of baffle unit 500, according to the preferred embodiment of FIG. 5A. FIG. 5C shows a sectional view through the section 5-5 of FIG. 5B, according to the preferred embodiment of FIG. 5A. In use, baffle unit 500 preferably is positioned inside of electrolysis chamber 105 beneath electrode plates 605, as best shown in FIG. 2. This arrangement preferably assists providing even flow distribution of water 180 pumped from water tank 160 over the surfaces of electrode plates 605 contained in electrolysis chamber 105. Furthermore, the even distribution of water flow over the surfaces of electrode plates 605 preferably assists preventing accumulation of hydrogen gas and oxygen gas products on the surfaces of electrode plates 605. Accumulation of hydrogen and oxygen gas on the surfaces of electrode plates 605 could possibly lead to an attenuation of the effective charge on the surfaces of electrode plates 605, possibly leading to a reduction in electrolysis efficiency.

Baffle unit 500 preferably is comprised of a non-conducting material, preferably plastic, preferably polypropylene. Upon reading this specification, those with ordinary skill in the art will now appreciate that, under appropriate circumstances, considering such issues as design preference, manufacturer preference, cost, future technologies, etc., other material arrangements, such as, for polyethylene, nylon, other plastics, etc., may suffice.

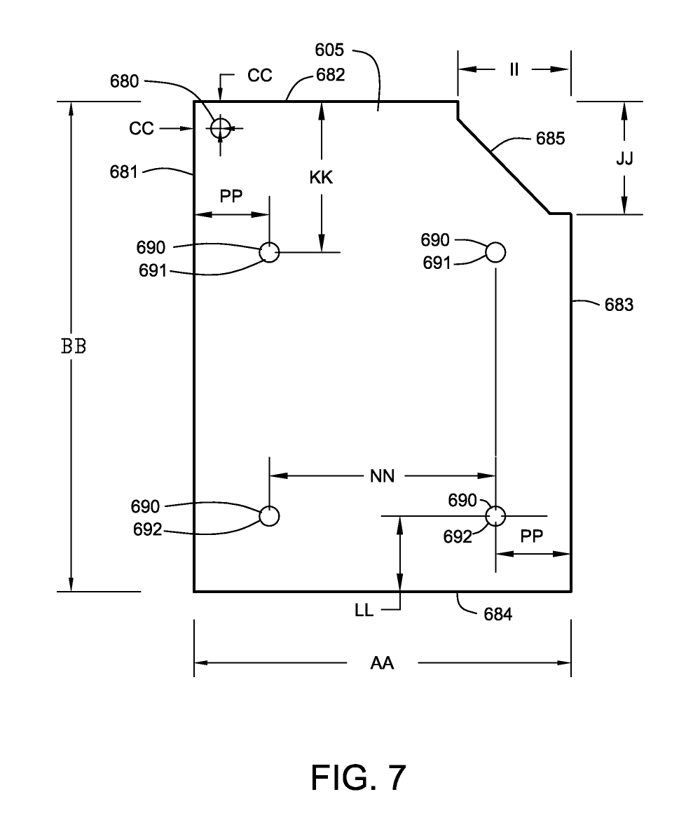

Baffle unit 500 preferably comprises a plurality of apertures 505, as shown in FIG. 5A and FIG. 5B. Each aperture 505 preferably transverses the entire width of baffle unit 500, as best shown in FIG. 5C. This arrangement preferably allows water 180 flowing through water inlet aperture 218 or water inlet aperture 219 (see FIG. 2) to pass through apertures 505 and distribute the flow of water 180 over the surface of electrolysis plates 605 (see FIG. 7).

Apertures 505 preferably comprise a diameter of about one-eighth of an inch (about ⅜ cm). Furthermore, apertures 505 preferably are spaced apart by about three-eighths of an inch (about ⅞ cm) (UA). Apertures 505 preferably comprise at least one row spacing of about one-quarter inch (about ⅝ cm) (UB). Upon reading this specification, those with ordinary skill in the art will now appreciate that, under appropriate circumstances, considering such issues as design preference, manufacturer preference, cost, future technologies, etc., other aperture diameter and spacing arrangements, such as, for example, smaller diameters, larger diameters, other spacing arrangements, etc., may suffice.

Baffle unit 500 preferably comprises non-perforated border 525, as shown. Non-perforated border 525 preferably comprises a width of about one-quarter of an inch (about ⅝ cm), as shown by dimension W in FIG. 5B. Upon reading this specification, those with ordinary skill in the art will now appreciate that, under appropriate circumstances, considering such issues as design preference, manufacturer preference, cost, future technologies, etc., other border thickness arrangements, such as, for example, wider borders, thinner borders, etc., may suffice.

Baffle unit 500 preferably comprises a length of about six inches (about 15¼ cm) and a width of about five inches (about 12.7 cm), as shown in FIG. 5A by dimensions GG and HH, respectively. Baffle unit 500 preferably comprises an overall thickness of about one half of an inch (about 1¼ cm), as shown by dimension U in FIG. 5A. Upon reading this specification, those with ordinary skill in the art will now appreciate that, under appropriate circumstances, considering such issues as design preference, manufacturer preference, cost, future technologies, etc., other baffle dimensions, such as, for example, other lengths, other widths, other thicknesses, other shapes, etc., may suffice.

Baffle unit 500 preferably comprises tapered bottom edge 540, as best shown in FIG. 5C. Tapered bottom edge 540 preferably provides clearance for welding between walls of electrolysis chamber 105 (or electrolysis chamber 305) when baffle unit 500 is placed on the bottom of electrolysis chamber 105 (see FIG. 2). Tapered bottom edge 540 preferably comprises a tapering of about 45 degrees, as shown. Tapered bottom edge 540 preferably comprises a height of about one-quarter of an inch (about ⅜ cm), as shown.

Baffle unit 500 preferably comprises at least one cavity space 550, as shown in FIG. 5C. Cavity space 550 preferably allows water 180 entering electrolysis chamber 105 to distribute to each of apertures 505. Cavity space 550 preferably comprises a thickness of about one-quarter of an inch (about ⅜ cm), as shown.

FIG. 6A shows a top view, illustrating the arrangement of electrode plates 605 of hydrogen fuel system 100, according to the preferred embodiment of FIG. 1. FIG. 6A shows the preferred arrangement of electrode plates 605 in stacked array 602 as contained in electrolysis chamber 105 for generation of Brown's gas 200. Electrical current preferably is provided to electrode plates 605 from electrical system 130 (see FIG. 1) through terminal 630 and terminal 632, as shown. Terminal 632 preferably is involved in supplying current flow from electrical system 130 to anode plates 620, and terminal 630 preferably is involved in drawing current flow from cathode plates 610 and directing current to electrical system 130. Terminal 630 and terminal 632 preferably project through left charging apertures 238 (or right charging apertures 239) of electrolysis chamber 105, as best shown in FIG. 2. Alternatively preferably, terminal 630 and terminal 632 preferably project through charging apertures 438 if electrolysis chamber 305 is employed (see FIG. 4).

Electrical connectivity between terminal 630 and cathode plates 610 preferably is provided by at least one bracket 640 and at least one connectivity pole 625, as shown (also see FIG. 6B). Likewise, electrical connectivity between terminal 632 and anode plates 620 preferably is provided by at least one bracket 642 and at least one connectivity pole 625, as shown (also see FIG. 6C). Bracket 640 preferably compensates with slightly different dimensions than bracket 642 in order to accommodate the one extra cathode plate 610 in stacked array 602 (See Table 1 for bracket dimensions). Bracket 640 and bracket 642 preferably comprise metallic, conducting material, preferably titanium. Connectivity poles 625 preferably comprise metallic, conducting material, preferably titanium. Upon reading this specification, those with ordinary skill in the art will now appreciate that, under appropriate circumstances, considering such issues as design preference, manufacturer preference, cost, future technologies, etc., other pole material arrangements, such as, for example, copper poles, stainless steel poles, aluminum poles, coated poles, other conducting poles, etc., may suffice.

TABLE 1
Plate Assembly Dimensions

| Measurement | US | | Metric | |
|---|---|---|---|---|
| AB | ~¾ | inch | ~2 | cm |
| AC | ~⅜ | inch | ~⅞ | cm |
| AD | ~1½ | inch | ~3⅞ | cm |
| AE | ~1⅞ | inch | ~4⅝ | cm |
| AF | ~2⅛ | inch | ~5⅜ | cm |
| AG | ~2 | inch | ~5 | cm |
| AH | ~2½ | inch | ~6⅓ | cm |
| AI | ~4 | inch | ~10 | cm |
| AJ | ~⅜ | inch | ~⅞ | cm |
| AK | ~1⅞ | inch | ~4¾ | cm |
| AL | ~2¼ | inch | ~5¾ | cm |
| AM | ~⅝ | inch | ~1⅛ | cm |
| AN | ~1¼ | inch | ~3⅛ | cm |
| AO | ~1 1/16 | inch | ~2⅞ | cm |
| AP | ~6 | inch | ~15¼ | cm |
| AQ | ~3 1/8 | inch | ~7 15/16 | cm |
| AR | ~2 3/8 | inch | ~5 15/16 | cm |
| AS | ~2⅞ | inch | ~7¼ | cm |
| AT | ~2⅛ | inch | ~5⅓ | cm |

FIG. 6B shows a side view, illustrating electrical connectivity between cathode plates 610, according to the preferred embodiment of FIG. 6A. Connectivity pole 625 preferably is inserted through each of cathode plates 610 in stacked array 602 through an aperture in each of cathode plates 610 (see below), in order to provide electrical connectivity between each of cathode plates 610 in stacked array 602 (see below). Connectivity pole 625 preferably comprises a cylindrical shape with an outer diameter of about one-quarter of an inch (about ⅜ cm). Upon reading this specification, those with ordinary skill in the art will now appreciate that, under appropriate circumstances, considering such issues as design preference, manufacturer preference, cost, future technologies, etc., other shapes and dimensions may suffice.

Washers 710 (see FIG. 6F) preferably are fitted over connectivity pole 625 between cathode plates 610, in order to preferably provide spacing between cathode plates 610. Washers 710 preferably comprise conductive material, preferably titanium. Washers 710 preferably comprise an inner diameter of about one-quarter of inch (about ⅜ cm), in order to accommodate the outer diameter of connectivity pole 625. Electrical current preferably is transmitted between cathode plates 610 by connectivity rod 625 (at least one cathode current-transmitter-assistor structured and arranged to assist transmission of current between such at least one plurality (n+1) of such at least one cathode plates), as shown. Current preferably exits cathode plates 610 through bracket 640 and terminal 630, as shown by current flow direction 604 in FIG. 6B.

FIG. 6C shows a side view, illustrating electrical connectivity between anode plates 620, according to the preferred embodiment of FIG. 6A. Connectivity pole 625 preferably is inserted through each of anode plates 620 through an aperture in each of anode plates 620, in order to preferably provide electrical connectivity between each of anode plates 620 (see below). Washers 710 (see FIG. 6F) preferably are fitted over connectivity pole 625 between anode plates 620, in order to preferably provide spacing between anode plates 620. The preferred titanium bolt spacers preferably comprise an inner diameter of about one-quarter of inch (about ⅜ cm), in order to accommodate the diameter of connectivity pole 625. The titanium bolt spacers preferably comprise a length of about two-sevenths of an inch (about ¾ cm) in order to separate anode plates 620 by about two-sevenths of an inch.

Current preferably is transmitted between anode plates 620 by connectivity pole 625 (at least one anode current-transmitter-assistor structured and arranged to assist transmission of current between such at least one number (n) of such at least one anode plates), as shown. Electrical current preferably enters anode plates 620 by traveling from terminal 632 and through bracket 642, as shown by current flow direction 607.

Stacked array 602 preferably comprises a plurality of reactors 612, as shown in FIG. 6B and FIG. 6C. Each reactor 612 (at least herein embodying wherein such electrolyzer means comprises electrolysis reactor means for performing electrolysis reaction with the water; and at least herein embodying wherein such at least one electrolyzer comprises at least one electrolysis reactor structured and arranged to perform electrolysis reaction with the water) preferably is comprised of one positively charged surface of one anode plate 620 and one negatively charged surface of one cathode plate 610 aligned in parallel, as shown, with the charged surfaces fully overlapped and separated by a preferred distance of about one-seventh of an inch (about 3½ mm). This arrangement at least embodies herein at least one parallel-alignment geometry structured and arranged to geometrically-align such at least one cathode plate and such at least one anode plate in at least one parallel arrangement; and this arrangement at least embodies herein at least one edge-alignment geometry structured and arranged to geometrically-align at least one bottom edge of such at least one cathode plate with at least one bottom edge of such at least one anode plate in at least one common plane.

Upon reading this specification, those with ordinary skill in the art will now appreciate that, under appropriate circumstances, considering such issues as design preference, manufacturer preference, cost, future technologies, etc., other plate separation arrangements, such as, for example, greater plate separations, smaller plate separations, etc., may suffice.

Each individual reactor 612 provides a system sufficient for the production of Brown's gas 200 from water 180. Hydrogen fuel system 100 preferably comprises an alternating arrangement of at least one number (n) of anode plates 620 and at least one plurality (n+1) of cathode plates 610, as shown. Such an arrangement generates (2n) reactors 612 arranged in a sequence for production of Brown's gas 200 from water 180.

Hydrogen fuel system 100 preferably comprises a total of twenty-five electrode plates 605, preferably comprising an alternating arrangement of twelve anode plates 620 and thirteen cathode plates 610, generating a series of twenty-four reactors 612, as shown. Applicant has noted, in testing, a decrease in fuel efficiency in hydrogen fuel system 100 when employing less than a total of thirteen electrode plates 605.

The separation between each electrode plates 605 in stacked array 602 preferably is maintained by positioning a series of washers 711 (see FIG. 6F) of suitable thickness to separate electrode plates 605 by about one-eighth of an inch (about ⅜ cm) in stacked array 602 (see details below) (this arrangement at least embodying herein at least one surface-separator structured and arranged to separate such at least one of such at least two surfaces of negative electrical charge from such at least one of such at least two surfaces of positive electrical charge by at least one fixed separation). Applicant has noted an optimized production of Brown's gas 200 when electrode plates 605 are separated by the above distance at a constant current input.

FIG. 6D shows a perspective view, illustrating bracket 640 and terminal 630, according to the preferred embodiment of FIG. 6A. Terminal 630 preferably comprises at least one bolt 631, as shown. Bolt 631 preferably comprises at least one conductive bolt, preferably at least one titanium bolt, preferably at least one titanium bolt comprising twenty threads per inch. Bolt 631 preferably is welded to bracket 640. Bolt 631 preferably comprises a diameter of about one-quarter of an inch (about ⅝ cm) and a length of about one and three-fourths inches (about 2 cm). Upon reading this specification, those with ordinary skill in the art will now appreciate that, under appropriate circumstances, considering such issues as design preference, manufacturer preference, cost, future technologies, etc., other bolt dimensional arrangements, such as, for example, other diameters, other lengths, etc., may suffice.

Bolt 631 preferably is located on bracket 640 such that pole 633 projects through the center of left charging aperture 238 (or right charging aperture 239) of electrolysis chamber 105 (see FIG. 2). Bolt 631 preferably is located about two inches (about 5 cm) from junction 665 of bracket 640, as shown by dimension AG in FIG. 6D. This arrangement preferably assists preventing pole 633 from coming into contact with the peripheral edges of left charging aperture 238 (or of right charging aperture 239) of lid 210 (see FIG. 2). In use, a non-conductive sleeve, preferably a nylon sleeve, preferably is positioned around pole 633 in order to preferably assist preventing pole 633 from coming into contact with, and possibly melting, the peripheral edges of left charging aperture 238 (or right charging aperture 239) of lid 210 (see FIG. 9).

Bracket 640 preferably comprises at least one aperture 660, as shown. Aperture 660 preferably is structured and arranged to receive connectivity pole 625, as best shown in FIG. 6B. Connectivity pole 625 preferably comprises at least one bolt, preferably at least one bolt comprising a quarter-inch diameter (about 2 cm) with twenty threads per inch.

FIG. 6E shows a perspective view, illustrating bracket 642 and terminal 632, according to the preferred embodiment of FIG. 6A. Terminal 632 preferably comprises at least one bolt 631, as shown. Bolt 631 preferably comprises at least one conductive bolt, preferably at least one titanium bolt, preferably at least one titanium bolt comprising twenty threads per inch. Bolt 631 preferably is welded to bracket 642, as shown. Bolt 631 preferably is located on bracket 642 such that pole 633 projects through the center of left charging aperture 238 (or right charging aperture 239) (see FIG. 2). Bolt 631 preferably is located about one and seven-eighths inch (4¾ cm) from junction 667 of bracket 642, as shown by dimension AK in FIG. 6E. This arrangement preferably assists preventing pole 633 from coming into contact with the edges of left charging aperture 238 (or right charging aperture 239). In use, a non-conductive sleeve, preferably a nylon sleeve, preferably is positioned around pole 633 in order to preferably assist preventing pole 633 from coming into contact with, and possibly melting, the peripheral edges of left charging aperture 238 (or right charging aperture 239) of lid 210 (see FIG. 9).

Bracket 642 preferably comprises at least one aperture 662, as shown. Aperture 662 preferably is structured and arranged to receive connectivity pole 625 (see FIG. 6C).

Each pole 633 preferably is centered on stacked array 602. Additional geometric specifications of bracket 640 and bracket 642 are provided in Table 1.

FIG. 6F shows a side view, illustrating the alignment of electrode plates 605 with at least one aligning bolt 701 and the separation of electrode plates 605 with washers 710 and washers 711, according to the preferred embodiment of FIG. 6A. Electrode plates 605 preferably are aligned to generate stacked array 602 (see FIG. 6A-FIG. 6C) preferably using such at least one alignment bolt 701, preferably at least four alignment bolts 701, as shown. Alignment bolts 701 preferably are inserted through apertures 690 of electrode plates 605 (see FIG. 7). Alignment bolts 701 preferably comprise non-conducting material, preferably nylon material. Upon reading this specification, those with ordinary skill in the art will now appreciate that, under appropriate circumstances, considering such issues as design preference, manufacturer preference, cost, future technologies, etc., other bolt materials, such as, for example, glass bolts, fluoropolymer bolts, other non-conducting bolts, etc., may suffice.

Each cathode plate 610 and each anode plate 620 in stacked array 602 preferably are separated by at least one washer 711, preferably four washers 711 (one on each of such four alignment bolts 701), as shown. Washers 711 preferably are hollow-cylindrical-shaped and preferably fit over each alignment bolt 701, as shown. Washers 711 preferably are sized to separate the charged surfaces of electrode plates 605 by about one-eighth of an inch (about ⅜ cm). Washers 711 preferably comprise non-conductive material, preferably nylon. Upon reading this specification, those with ordinary skill in the art will now appreciate that, under appropriate circumstances, considering such issues as design preference, manufacturer preference, cost, future technologies, etc., other non-conductive materials, such as, for example, plastic materials, fluoropolymer materials, other non-conductive polymers, etc., may suffice.

Cathode plates 610 preferably are separated along connectivity pole 625 by washers 710, as shown. Washers 710 preferably are hollow-cylindrical-shaped and preferably fit over connectivity pole 625, as shown. Washers 710 preferably comprise titanium washers. Likewise, anode plates 620 preferably are spaced by washers 710, as shown. Washers 710 preferably comprise an inner diameter of about ¼-inch (about ⅔ cm), an outer diameter of about ½-inch (about 1⅓ cm), and a length of about ⅓-inch (about ¾ cm).

FIG. 7 shows a front view, illustrating electrode plate 605, according to the preferred embodiment of FIG. 1. Electrode plate 605 preferably will perform as a cathode plate 610 or an anode plate 620 in hydrogen fuel system 100, depending if it is electrically connected to terminal 630 (see FIG. 6B) or terminal 632 (see FIG. 6C).

Electrode plates 605 utilized by hydrogen fuel system 100 preferably comprise metal plates capable of electrical conductivity, preferably corrosion-resistant electrode plates, preferably titanium electrode plates, preferably mixed metal oxide (MMO) coated titanium plates, preferably iridium-tantalum oxide coated titanium plates. Upon reading the teachings of this specification, those skilled in the art will now appreciate that, under appropriate circumstances, considering such issues as available materials, future technologies, cost, etc., other materials, such as, for example, other non-corrosive metals, other corrosive-resistant-coated metals, other conductors, etc., may suffice.

Electrode plates 605 employed by hydrogen fuel system 100 preferably comprise a coating thickness of between about eight to about twelve microns. Upon reading this specification, those with ordinary skill in the art will now appreciate that, under appropriate circumstances, considering such issues as design preference, manufacturer preference, cost, future technologies, etc., other electrode material arrangements, such as, for example, lead plates, molybdenum plates, stainless steel plates, other conducting plate types, etc., may suffice. Furthermore, upon reading this specification, those with ordinary skill in the art will now appreciate that, under appropriate circumstances, considering such issues as design preference, manufacturer preference, cost, future technologies, etc., other electrode plate coating arrangements, such as, for example, other mixed metal oxide coatings, etc., may suffice.

Electrode plate 605 preferably comprises a length of about five inches (about 12.7 cm) and a height of about seven inches (about 17¾ cm), as shown by dimensions AA and BB in FIG. 7. Upon reading this specification, those with ordinary skill in the art will now appreciate that, under appropriate circumstances, considering such issues as design preference, manufacturer preference, cost, future technologies, etc., other electrode dimensional arrangements, such as, for example, smaller, wider, other electrode shapes, etc., may suffice.

Electrode plate 605 preferably comprises at least one connectivity rod aperture 680 which preferably provides an insertion point for connectivity pole 625 (see FIG. 6B and FIG. 6D). Connectivity rod aperture 680 preferably is located about three-eighths of an inch (about ⅞ cm) from left edge 681 of electrode plate 605, and about three-eighths of an inch (about ⅞ cm) from top edge 682 of electrode plate 605, as shown by dimension CC in FIG. 7. Upon reading this specification, those with ordinary skill in the art will now appreciate that, under appropriate circumstances, considering such issues as design preference, manufacturer preference, cost, future technologies, etc., other aperture location arrangements may suffice.

Electrode plate 605 preferably comprises at least one corner indentation 685, as shown. Corner indentation 605 preferably provides clearance for connectivity pole 625 passing through electrode plates 605 of the opposite charge. Corner indentation 685 preferably is located on the upper right corner of electrode plate 605, as shown. Corner indentation 685 preferably comprises a length of about one inch (about 2½ cm) along top edge 682 and a width of about one inch (about 2½ cm) along right edge 683, as shown by dimensions II and JJ, respectively.

Electrode plate 605 preferably comprises at least one aperture 690, preferably four apertures 690, as shown. Apertures 690 preferably are structured and arranged to receive alignment bolts 701 (see FIG. 6F). Apertures 690 preferably comprise at least two upper apertures 691 and at least two lower apertures 692, as shown. Upper apertures 691 preferably are located about two inches (about 5 cm) from top edge 682 and lower apertures 692 preferably are located about one inch (about 2½ cm) from bottom edge 684, as shown by dimensions KK and LL, respectively. Upper apertures 691 preferably are separated by about three inches (about 7⅝ cm), and lower apertures 692 preferably are separated by about three inches (about 7⅝ cm), as shown by dimension NN. Upper apertures 691 and lower apertures 692 preferably are about one inch (about 2½ cm) from either left edge 681 or right edge 683, as shown by dimension PP, and preferably are flip symmetric. Upon reading this specification, those with ordinary skill in the art will now appreciate that, under appropriate circumstances, considering such issues as design preference, manufacturer preference, cost, future technologies, etc., other aperture arrangements, such as, for example, other dimensions, other locations on the electrode plate, fewer apertures, more apertures, etc., may suffice.

When in stacked array 602, adjacent electrode plates 605 are reversed (left to right) related to each other, such that connectivity rod aperture 680 of one plate aligns with corner indentation 685 of the other. Further, when in stacked array 602, adjacent electrode plates 605 also align with respect to apertures 690, upper apertures 691 being reversed (left to right), and also lower apertures 692 being reversed (left to right), correspondingly with the alignment of connectivity rod aperture 680 and corner indentation 685.

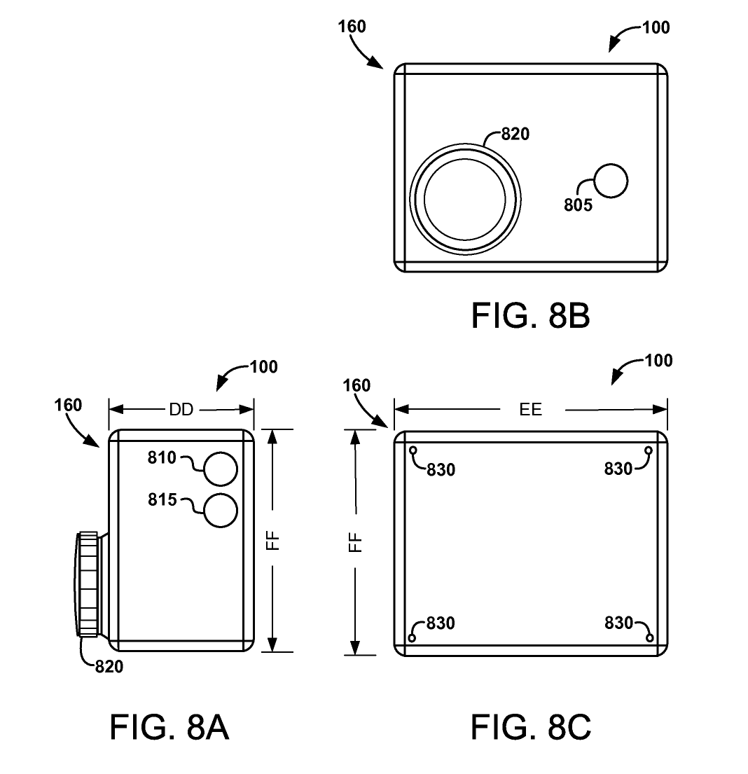

FIG. 8A shows a side view, illustrating water tank 160, according to the preferred embodiment of FIG. 1. FIG. 8B shows a top view, illustrating water tank 160, according to the preferred embodiment of FIG. 8A. FIG. 8C shows a bottom view, illustrating water tank 160, according to the preferred embodiment of FIG. 8A.

Water tank 160 preferably is comprised of plastic, preferably polypropylene. Water tank 160 preferably comprises a height of about eight inches (about 20 cm) and a length of about fifteen inches (about 38 cm), as shown by dimension DD and EE, respectively. Water tank 160 preferably comprises a width of about twelve inches (about 30½ cm), as shown by dimension FF in FIG. 8C.

Water tank 160 preferably comprises at least one product outlet aperture 805, as shown in FIG. 8B. Product outlet aperture 805 preferably connects to hydrogen fuel conduit 170 (see FIG. 1) in order to transfer Brown's gas 200 to internal combustion engine 110. Hydrogen fuel conduit 170 preferably is connected to product outlet aperture 805 preferably using at least one sealing coupler, preferably at least one spin weld fitting, in order to preferably prevent leakage of Brown's gas 200.

Water tank 160 preferably comprises at least one water inlet aperture 810 and at least one water outlet aperture 815, as shown in FIG. 8A. Water inlet aperture 810 and water outlet aperture 815 preferably are located on the bottom of water tank 160, as shown. Water inlet aperture 810 preferably is connected to product conduit 165 in order to receive water 180 and Brown's gas 200 from electrolysis chamber 105 (see FIG. 1). Product conduit 165 preferably is connected to water inlet aperture 810 using at least one sealing coupler, preferably at least one spin weld fitting, in order to preferably prevent leakage of Brown's gas 200 and water 180. Water outlet aperture 815 preferably is connected to water conduit 175 in order to transfer water 180 to electrolysis chamber 105 (see FIG. 1). Water conduit 175 preferably is connected to water outlet aperture 815 preferably using at least one sealing coupler, preferably a spin weld fitting, in order to preferably prevent leakage of water 180.

Water tank 160 preferably comprises cap 820, as shown. Cap 820 preferably may be removed from water tank 160 to allow refilling of water tank 160 with water 180.

Water tank 160 preferably further comprises at least one threaded insert 830, preferably at least four threaded inserts 830, preferably for mounting water tank 160, as shown. Each threaded insert 830 preferably is about one-quarter inch (about ⅝ cm) from two sides of water tank 160, preferably on the bottom of water tank 160, as shown. Threaded insert preferably comprises ¼-20 threading about one-half inch (about 1¼ cm) deep. Upon reading the teachings of this specification, those skilled in the art will now appreciate that, under appropriate circumstances, considering such issues as future technologies, cost, available materials, etc., other mounting mechanisms, such as, for example, straps, clamps, couplers, etc., may suffice. Upon reading the teachings of this specification, those skilled in the art will now appreciate that, under appropriate circumstances, considering such issues as future technologies, cost, available materials, etc., other dimensions, such as, for example, deeper, shallower, metric, other measurement standards, etc., may suffice.

FIG. 9 shows a diagrammatic exploded view, illustrating at least one pole assembly 460, according to a preferred embodiment of the present invention.

Pole assembly 460 preferably prevents contact between pole 633 and lid 470 (representative of each electrolysis chamber lid of all embodiments of hydrogen fuel system 100), which potentially may melt material of lid 470. Pole assembly preferably comprises at least one terminal 464, at least one insulative washer 458, at least one seal 456, at least one insulative spacer 454, at least one conductive washer 452 and at least one mounting coupler 450.

Insulative washer 458 and insulative spacer 454, preferably comprise at least one heat and electrically insulative material, preferably nylon. Terminal 464 preferably comprises bolt 631 and mounting coupler 450 preferably comprises at least one nut. Bolt 631 and such at least one nut preferably comprise ¼-20 threading. Conductive washer 452, terminal 464, and mounting coupler 450 preferably comprise titanium. Seal 456 preferably comprises at least one o-ring, preferably at least one silicon o-ring. Seal preferably comprises at least one thickness of about one-sixteenth inch (about 3 mm).

Insulative washer 458 preferably comprises a thickness of about one-eighth inch (about ⅜ cm), an outer diameter of about five-eighths inch (about 1½ cm), and an inner diameter of about one-quarter inch (about ⅝ cm). Insulative spacer 454 preferably comprises a T-shaped cross-section, preferably comprising a head and body. Such head of insulative spacer 454 preferably comprises a thickness of about one-eighth inch (about ⅜ cm), an outer diameter of about five-eighths inch (about 1½ cm), and an inner diameter of about one-quarter inch (about ⅝ cm). Such body of insulative spacer 454 preferably comprises a thickness of about seven-sixteenths inch, an outer diameter of about three-eighths inch (about ⅞ cm), and an inner diameter of about one-quarter inch (about ⅝ cm). Thickness of body of insulative spacer 454 and seal 456 preferably corresponds to thickness of lid 470.

When assembled, as shown, through charging aperture 462 (representative of all charging apertures of hydrogen fuel system 100) tightening of pole assembly 460 preferably seals charging aperture 462 from leaks, and preferably prevents pole 633 from contacting lid 470.

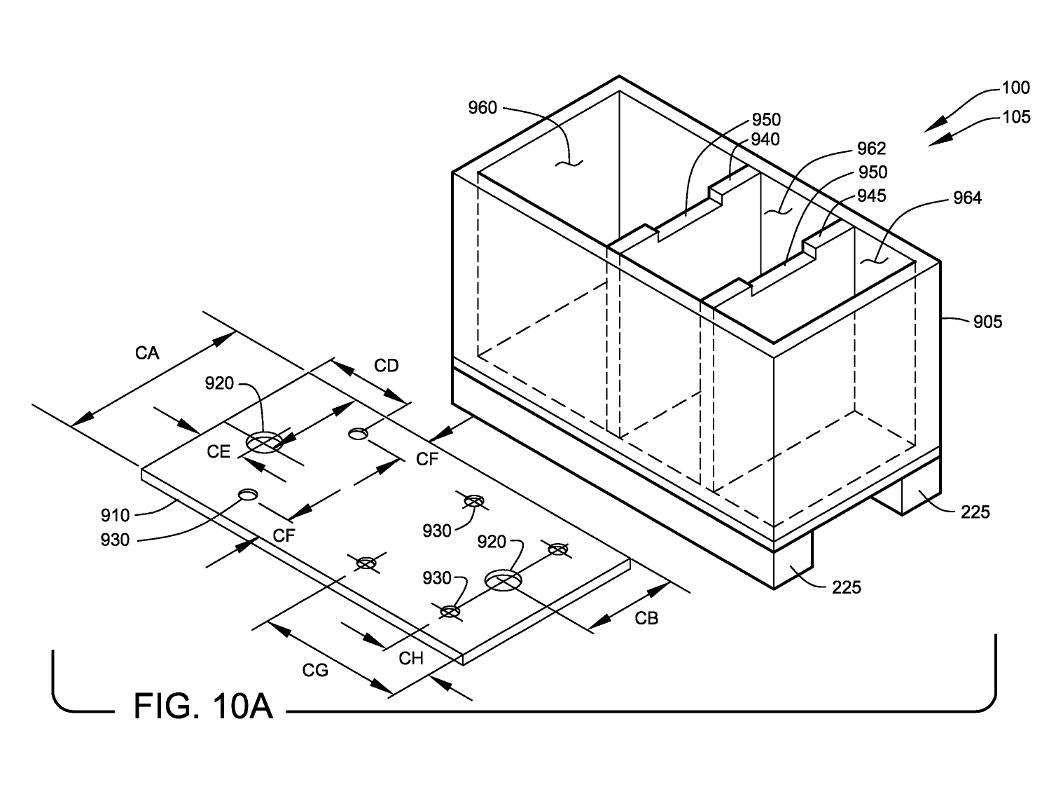

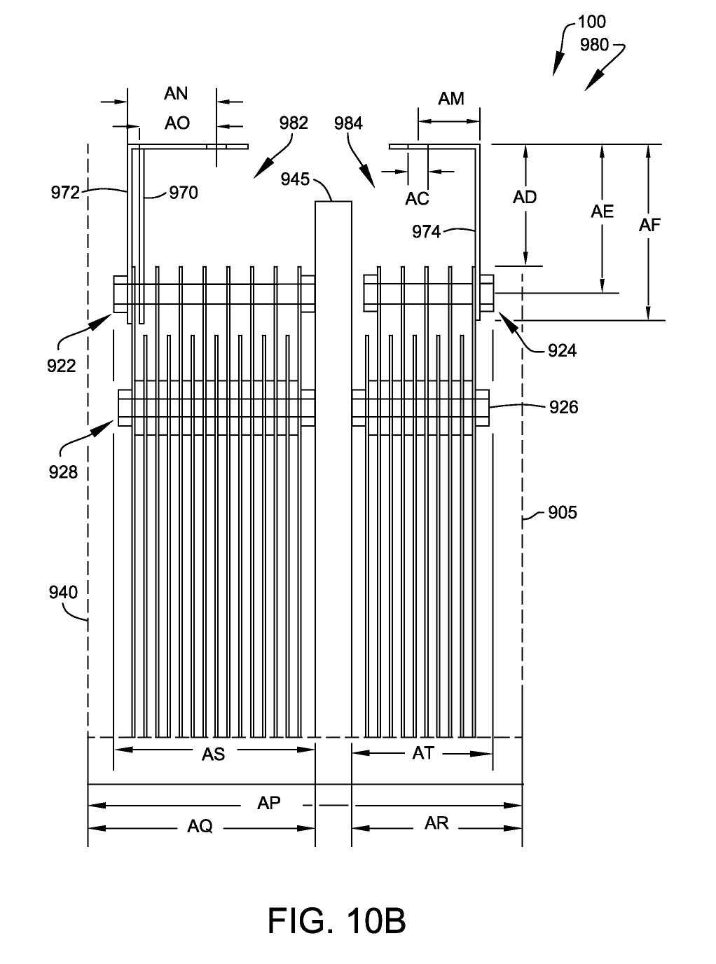

FIG. 10A shows a perspective view, illustrating an alternately preferred housing 905, according to a preferred embodiment of the present invention. FIG. 10B shows a side view, illustrating an alternately preferred dual stacked array 980, according to the preferred embodiment of FIG. 10A. Although many of the features of housing 905 are repeated from housing 205, housing 905 preferably comprises three electrolysis chambers. Chamber 960 preferably houses one stacked array 602 comprising 25 electrode plates 605. Chamber 962 preferably houses one stacked array 602 comprising 15 electrode plates 605. Chamber 964 preferably houses one stacked array 602 comprising 10 electrode plates 605.

Housing 905 preferably further comprises chamber divider 940 and chamber divider 945. Chamber divider 940 and chamber divider 945 preferably comprise at least one fluid aperture 950, preferably located at the top of each chamber divider. Fluid aperture 950 preferably permits equalization of fluid pressure between each chamber. Two baffle units 500 preferably rest at the bottom of housing 905, a first baffle unit (being 6-inch by 5-inch) in chamber 906, and a second baffle unit (being 6-inch by 6-inch) in both chamber 962 and chamber 964. Chamber divider 945 rests on top of such second baffle unit and disperses fluid flow from at least one common inlet into both chambers.

Housing 905 preferably further comprises at least one lid 910. Although many of the features of Lid 910 are repeated from lid 210, lid 910 preferably comprises three pair of charging apertures 930, preferably located to accommodate electrical connection to three stacked arrays 602. Stacked array 602 housed in chamber 960 is as described in FIGS. 6A-6F. FIG. 10B Illustrates dual stacked array 980, preferably comprising stacked array 982, stacked array 984 and chamber divider 945.

Stacked array 982 preferably comprises bracket 972 and bracket 970, containing features similar to bracket 640 and bracket 642, however have been adjusted in length to accommodate placement of pole 633 centered on stacked array 982. Likewise stacked array 984 preferably comprises two brackets 974 (anode and cathode) similarly altered to place pole 633 centered on stacked array 984. Further, bracket 972 and bracket 970 preferably attach on the same end of stacked array 982, as shown, opposite brackets 974, likewise place along a common end of stacked array 984.

Similarly, connectivity pole 922 and connectivity pole 924 as well as aligning bolt 928 and aligning bolt 926 are adjusted in length to accommodate variation in number of electrode plates 605 in each respective stacked array. Preferred dimensions are provided in Table 2 for housing 905 and in Table 1 for dual stacked array 980.

In use, controller unit 140 utilizes the three unique chambers to generate Brown's gas in incrementally distinct amounts corresponding to 10 plates, 15 plates, 25 plates, 35 plates, 40 plates, and 50 plates. Controller unit 140 preferably adjusts incrementally between different numbers of active plates for between about 250 rpm and 300 rpm of engine speed variation.

TABLE 2
Housing Dimensions

| Measurement | US | | Metric | |
|---|---|---|---|---|
| CA | ~6½ | inch | ~16½ | cm |
| CB | ~3¼ | inch | ~8¼ | cm |
| CD | ~3 | inch | ~7⅝ | cm |
| CE | ~1½ | inch | ~3⅞ | cm |
| CF | ~1⅛ | inch | ~2⅞ | cm |
| CG | ~4 15/16 | inch | ~12½ | cm |
| CH | ~1 11/16 | inch | ~4¼ | cm |

Although applicant has described applicant's preferred embodiments of this invention using English and metric standardized units, such measurements have been provided only for the convenience of the reader and should not be read as controlling or limiting. Instead, the reader should interpret any measurements provided in English standardized units as controlling. Any measurements provided in metric standardized units were merely derived through strict mechanical coding, with all converted values rounded to two decimal places.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A system, relating to electrolyzing water, when electrically coupled to at least one electrical source, to provide at least one combustible hydrogen fuel to at least assist fueling at least one internal combustion engine, comprising:
a) at least one electrolyzer structured and arranged to electrolyze the water to produce hydrogen and oxygen;
b) wherein said at least one electrolyzer comprises at least one electrolysis reactor structured and arranged to perform at least one electrolysis reaction with the water; and
c) at least one continuous-flow circulator structured and arranged to circulate a continuous flow of the water through said at least one electrolyzer;
d) wherein said at least one continuous-flow circulator comprises at least one product sweeper structured and arranged to sweep such hydrogen and such oxygen through said at least one electrolysis reactor; and
e) wherein such hydrogen and such oxygen are available to inject in the at least one internal combustion engine to assist fueling the at least one internal combustion engine.

2) The system according to claim 1 wherein said at least one electrolyzer further comprises at least one reactor-container structured and arranged to contain said at least one electrolysis reactor.

3) The system according to claim 1 wherein said at least one electrolyzer further comprises at least one directionally-alternating electric field generator structured and arranged to generate at least one directionally-alternating series of electric fields.

4) The system according to claim 3 wherein said at least one electrolysis reactor comprises:
a) at least one cathode plate structured and arranged to provide at least two surfaces of negative electrical charge; and
b) at least one anode plate structured and arranged to provide at least two surfaces of positive electrical charge;
c) wherein such hydrogen is produced at at least one of such at least two surfaces of negative electrical charge; and
d) wherein such oxygen is produced at at least one of such at least two surfaces of positive electrical charge.

5) The system according to claim 4 wherein said at least one electrolysis reactor further comprises:
a) at least one parallel-alignment geometry structured and arranged to geometrically-align said at least one cathode plate and said at least one anode plate in at least one parallel arrangement;
b) at least one edge-alignment geometry structured and arranged to geometrically-align at least one bottom edge of said at least one cathode plate with at least one bottom edge of said at least one anode plate in at least one common plane; and
c) at least one surface-separator structured and arranged to separate such at least one of such at least two surfaces of negative electrical charge from such at least one of such at least two surfaces of positive electrical charge by at least one fixed separation.

6) The system according to claim 5 wherein said at least one electrolyzer further comprises:
a) at least one number (n) of said at least one anode plates; and
b) at least one plurality (n+1) of said at least one cathode plates.

7) The system according to claim 6 wherein said at least one electrolyzer is further structured and arranged to comprise:
a) in at least one alternating arrangement, said at least one number (n) of said at least one anode plates and said at least one plurality (n+1) of said at least one cathode plates in at least one alternating ordered sequence;
b) wherein such at least one alternating arrangement generates at least one plurality (2n) of said at least one electrolysis reactors.

8) The system according to claim 7 wherein:
a) said at least one cathode plate comprises at least one titanium plate; and
b) said at least one anode plate comprises at least one titanium plate.

9) The system according to claim 8 wherein such at least one titanium plate comprises at least one mixed metal oxide coating.

10) The system according to claim 9 wherein such at least one mixed metal oxide coating comprises at least one iridium-titanium oxide coating.

11) The system according to claim 7 further comprising:
a) at least one cathode current-transmitter-assistor structured and arranged to assist transmission of current between said at least one plurality (n+1) of said at least one cathode plates; and
b) at least one anode current-transmitter-assistor structured and arranged to assist transmission of current between said at least one number (n) of said at least one anode plates.

12) The system according to claim 11 wherein:
a) said at least one cathode current-transmitter-assistor comprises at least one titanium pole; and
b) said at least one anode current-transmitter-assistor comprises at least one titanium pole.

13) The system according to claim 12 further comprising at least one water-flow distributor structured and arranged to distribute water flow evenly to each of said at least one plurality of said at least one electrolysis reactors.

14) The system according to claim 13 wherein said at least one water-flow distributor comprises at least one baffle distributor.

15) The system according to claim 14 further comprising at least one water storer structured and arranged to store the water for electrolysis by said at least one electrolyzer.

16) The system according to claim 15 wherein said at least one continuous-flow circulator comprises at least one pump structured and arranged to pump the water between said at least one water storer and said at least one electrolyzer.

17) The system according to claim 16 wherein said at least one water storer comprises at least one water-deliverer structured and arranged to deliver the water to said at least one electrolyzer.

18) The system according to claim 17 wherein said at least one water storer comprises at least one water-receiver structured and arranged to receive both un-reacted water and such hydrogen and such oxygen, from said at least one electrolyzer.

19) The system according to claim 18 wherein said at least one water storer comprises at least one product separator structured and arranged to separate such hydrogen and such oxygen from such un-reacted water.

20) The system according to claim 19 wherein said at least one water storer comprises at least one product-deliverer structured and arranged to deliver such hydrogen and such oxygen, separated by said at least one product separator, to the at least one internal combustion engine.

21) The system according to claim 1 further comprising:
a) a varying plurality of said at least one electrolysis reactor structured and arranged to electrolyze the water to produce hydrogen and oxygen at differing rates; and
b) at least one electrolysis rate controller structured and arranged to control production rate of hydrogen and oxygen;
c) wherein said at least one electrolysis rate controller variably activates different electrolysis reactors to control such production rate.

22) A system, relating to electrolyzing water, when electrically coupled to at least one electrical source, to provide at least one combustible hydrogen fuel to at least assist fueling at least one internal combustion engine, comprising:
a) at least one electrolyzer structured and arranged to electrolyze water to produce hydrogen and oxygen;
b) wherein said at least one electrolyzer comprises at least one electrolysis reactor structured and arranged to perform at least one electrolysis reaction with the water; and
c) at least one continuous-flow circulator structured and arranged to circulate a continuous flow of the water through said at least one electrolyzer;
d) wherein said at least one continuous-flow circulator comprises at least one product sweeper structured and arranged to sweep such hydrogen and such oxygen through said at least one electrolysis reactor;
e) wherein said at least one electrolyzer further comprises at least one reactor-container structured and arranged to contain said at least one electrolysis reactor;
f) wherein said at least one electrolyzer further comprises at least one directionally-alternating electric field generator structured and arranged to generate at least one directionally-alternating series of electric fields;
g) wherein said at least one electrolysis reactor comprises
i) at least one cathode plate structured and arranged to provide at least two surfaces of negative electrical charge, and
ii) at least one anode plate structured and arranged to provide at least two surfaces positive electrical charge,
iii) wherein such hydrogen is produced on at least one of such at least two surfaces of negative electrical charge, and
iv) wherein such oxygen is produced on at least one of such at least two surfaces of positive electrical charge;
h) wherein said at least one electrolysis reactor further comprises
i) at least one parallel-alignment geometry structured and arranged to geometrically-align said at least one cathode plate and said at least one anode plate in a parallel arrangement,
ii) at least one edge-alignment geometry structured and arranged to geometrically-align at least one bottom edge of said at least one cathode plate with at least one bottom edge of said at least one anode plate in at least one common plane, and
iii) at least one surface-separator structured and arranged to separate such at least one of such at least two surfaces of negative electrical charge from such at least one of such at least two surfaces of positive electrical charge by a fixed separation;
i) wherein said at least one electrolyzer further comprises
i) at least one number (n) of said at least one anode plates, and
ii) at least one plurality (n+1) of said at least one cathode plates;
j) wherein said at least one electrolyzer is further structured and arranged to comprise, in at least one alternating arrangement, said at least one number (n) of said at least one anode plates and said at least one plurality (n+1) of said at least one cathode plates in at least one alternating ordered sequence;
k) wherein such at least one alternating arrangement generates at least one plurality (2n) of said at least one electrolysis reactors; and
l) wherein said at least one surface-separator separates such at least one of such at least two surfaces of negative electrical charge and such at least one of such at least two surfaces of positive electrical charge by about one-seventh of an inch.

23) The system according to claim 22 wherein:
a) said at least one number (n) of said at least one anode plates comprises at least six plates; and
b) said at least one plurality (n+1) of said at least one cathode plates comprises at least seven plates;
c) wherein said at least one cathode plate comprises at least one titanium plate with a width of about five inches and a height of about seven inches;
d) wherein said at least one anode plate comprises at least one titanium plate with width of about five inches and a height of about seven inches; and
e) wherein such at least one titanium plate comprises at least one mixed metal oxide coating; and
f) at least one cathode current-transmitter structured and arranged to assist transmission of current between said at least one plurality (n+1) of said at least one cathode plates; and
g) at least one anode current-transmitter-assistor structured and arranged to assist transmission of current between said at least one number (n) of said at least one anode plates;
h) wherein said at least one cathode current-transmitter-assistor comprises at least one titanium pole; and
i) wherein said at least one anode current-transmitter-assistor comprises at least one titanium pole; and
j) at least one water-flow distributor structured and arranged to distribute water flow evenly to each of said at least one plurality of said at least one electrolysis reactors;
k) wherein said at least one water-flow distributor comprises at least one baffle-distributor; and
l) at least water storer structured and arranged to store the water for electrolysis by said at least one electrolyzer;
m) wherein said at least one continuous-flow circulator comprises at least one pump structured and arranged to pump the water between said at least one water storer and said at least one electrolyzer;
n) wherein said at least one pump pumps the water at a flow rate of about three and a half gallons per minute;
o) wherein said at least one water storer comprises at least one water-deliverer structured and arranged to deliver the water to said at least one electrolyzer;
p) wherein said at least one water storer comprises at least one water-receiver structured and arranged to receive un-reacted water and such hydrogen and such oxygen from said at least one electrolyzer;
q) wherein said at least one water storer comprises at least one product separator structured and arranged to separate such hydrogen and such oxygen from such un-reacted water;
r) wherein said at least one water storer comprises at least one product-deliverer structured and arranged to deliver such hydrogen and such oxygen, separated by said at least one product separator, to the at least one internal combustion engine;
s) wherein said at least one reactor-container comprises
i) at least one water-inlet structured and arranged to provide at least one water-inlet for receiving the water from said at least one water deliverer,
ii) at least one cathode-charging aperture structured and arranged to provide an aperture to charge said at least one plurality of said at least one cathode plates, and
iii) at least one anode-charging aperture structured and arranged to provide an aperture to charge such at least one number (n) of said at least one anode plates; and
t) at least one co-combustor structured and arranged to co-combust such hydrogen, produced by said at least one electrolyzer, with at least one hydrocarbon fuel source;
u) wherein such co-combustion of such hydrogen with such at least one hydrocarbon fuel source improves the fuel efficiency of the at least one internal combustion engine.

24) A system, relating to electrolyzing water, when electrically coupled to at least one electrical source, to provide at least one combustible hydrogen fuel to at least assist fueling at least one internal combustion engine, comprising:
a) at least one electrolyzer structured and arranged to electrolyze the water to produce hydrogen and oxygen;
b) wherein said at least one electrolyzer comprises at least one electrolysis reactor structured and arranged to perform electrolysis reaction with the water; and
c) wherein said at least one electrolyzer further comprises at least one directionally-alternating electric field generator structured and arranged to generate at least one directionally-alternating series of electric fields; and
d) at least one continuous-flow circulator structured and arranged to circulate continuous flow of the water through said at least one electrolyzer;
e) wherein such hydrogen and such oxygen are available to inject in the at least one internal combustion engine to assist fueling the at least one internal combustion engine.

25) A system, relating to electrolyzing water, when electrically coupled to at least one electrical source, to provide at least one combustible hydrogen fuel to at least assist fueling at least one internal combustion engine, comprising:
a) electrolyzer means for electrolyzing water to produce hydrogen and oxygen;
b) wherein said electrolyzer means comprises electrolysis reactor means for performing at least one electrolysis reaction with the water; and
c) continuous-flow circulator means for circulating a continuous flow of the water through said electrolyzer means;
d) wherein said continuous-flow circulator means comprises product sweeper means for sweeping such hydrogen and such oxygen through said electrolysis reactor means; and
e) wherein such hydrogen and such oxygen are available to inject in the at least one internal combustion engine to assist fueling the at least one internal combustion engine.
